(19) United States
(12) Patent Application Publication
(10) Pub. No.: US 2008/0074025 A1
(43) Pub. Date: Mar. 27, 2008

(54) Spark plug for internal combustion engine designed to keep ignitability of fuel high

(75) Inventor: Tsunenobu Hori, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/898,770

(22) Filed: Sep. 14, 2007

(30) Foreign Application Priority Data
Sep. 18, 2006 (JP) 2006-251966

(51) Int. Cl. H01T 13/20; H01T 21/02

(52) U.S. Cl. 313/141; 445/7

(57) ABSTRACT

A spark plug having a length for an internal combustion engine is provided which is designed to keep the ignitability of a gaseous fuel high to decrease a rise in voltage required by the spark plug to discharge, thereby prolonging the service life of the spark plug. The spark plug includes noble metal chips joined to a ground electrode and a center electrode to define a spark gap therebetween. At least one of the noble metal chips has a length of 0.3 mm or more and includes a portion whose sectional area traversing a lengthwise direction of the spark plug is greater than an area of a top end surface, thereby ensuring a higher degree of ignitability of the fuel and minimizing the rate of the rise in the required voltage.

### CROSS REFERENCE TO RELATED DOCUMENT

The present application claims the benefit of Japanese Patent Application No. 2006-251966 filed on Sep. 18, 2006, the disclosure of which is incorporated herein by reference.

### BACKGROUND OF THE INVENTION

1. Technical Field of the Invention

The present invention relates generally to a spark plug for internal combustion engines which may be employed in automotive vehicles, cogeneration systems, or gas feed pumps, and more particularly to such a spark plug designed to keep the ignitability of a gaseous fuel high to decrease a rise in voltage required by the spark plug to discharge, thereby prolonging the service life of the spark plug.

2. Background Art

Japanese Patent First Publication No. 2002-184551 teaches a spark plug for internal combustion engines which has noble metal chips joined to opposed surfaces of a ground and a center electrode to define a spark gap. The noble metal chips are each designed to have a decreased sectional area for facilitating the growth of a flame kernel, as produced in the spark gap, within a combustion chamber of the engine, thereby ensuring a higher degree of ignitability of an air-fuel mixture.

In recent years, increasing of a compression ratio of the engine and the degree of supercharging air into the engine have resulted in an increase in mechanical wear of the noble metal chips, thus leading to an increased rate of increase in size or length of the spark gap between the noble metal chips on the ground and center electrodes. The thinning of the noble metal chips, therefore, accelerates the increase in the length of the spark gap, thus resulting in a lack of dissipation of heat from the noble metal chips to the ground and center electrodes to accelerate the wear of the noble metal chips. The increase in the length of the spark gap will also result in an increase in flow rate of the mixture gas around the spark gap, which leads to a undesirable flow of sparks, i.e., a difficult in discharging a sequence of sparks in the spark gap. This gives rise to problems of a rise in voltage required by the spark plug to discharge and an increase in service life of the spark plug.

The thinning of the noble metal chip on the ground electrode serving as a positive electrode will also result in a decrease in range in which a sequence of sparks appear.

In order to decrease the required voltage, the length of the spark gap may be decreased or the noble metal chips may be thickened, but however, it will result in a decrease in ignitability of the fuel.

### SUMMARY OF THE INVENTION

It is therefore a principal object of the invention to avoid the disadvantages of the prior art.

It is another object of the invention to provide an improved structure of a spark plug for internal combustion engines which is designed to ensure a higher degree of ignitability of fuel and keep the voltage required by the spark plug to discharge low for prolonging the service life of the spark plug.

According to one aspect of the invention, there is provided a spark plug for internal combustion engines employed in, for example, automotive vehicles. The spark plug comprises: (a) a ground electrode having a center electrode facing surface; (b) a center electrode having a ground electrode facing surface; (c) a ground electrode noble metal chip joined to the center electrode facing surface of the ground electrode to have a top end surface oriented to the center electrode, the ground electrode noble metal chip extending from the center electrode facing surface by 0.3 mm or more; and (d) a center electrode noble metal chip joined to the ground electrode facing surface of the center electrode to have a top end surface oriented to the ground electrode to define a spark gap between itself and the top end surface of the ground electrode noble metal chip. At least one of the ground electrode noble metal chip and the center electrode noble metal chip includes a portion whose sectional area traversing a lengthwise direction of the spark plug is greater than an area of the top end surface of the at least one of the ground electrode noble metal chip and the center electrode noble metal chip.

Specifically, a top end of the one of the ground and center electrode noble metal chips is thin, thereby minimizing obstruction to the growth of a flame kernel in the spark gap to ensure the higher degree of ignitability of fuel. The formation of the thick portion of the noble metal chip improves the conductivity of heat to a corresponding one of the ground and center electrode to decrease the wear of the noble metal chip and also results in a decrease in amount of wear of the noble metal chip per unit time, which decreases the rate of increase in size of the spark gap to keep the voltage required by the spark plug to discharge at lower levels.

Additionally, when the thin top end of the noble metal chip is worn out, it will cause the thick portion to appear as the top end, thus resulting in an increase in range within which a sequence of sparks appear, thereby decreasing the rate of a rise in the required voltage. Before worn out, the thin top end ensures the range of the spark gap narrower in the radius direction of the spark plug, thus facilitating the growth of the flame kernel in the spark gap to provide the higher degree of ignitability of the fuel.

The noble metal chip projects from the center electrode facing surface of the ground electrode by 0.3 mm or more, thereby enhancing the above described improvement of the ignitability of the fuel.

In the preferred mode of the invention, the ground electrode noble metal chip is made up of a plurality of portions whose sectional areas traversing the lengthwise direction of the spark plug are different from each other. A minimum sectional area portion that is one of the plurality of portions having the smallest of the sectional areas is closest to the center electrode noble metal chip to have the top end surface.

Each of sectional areas of the minimum sectional area portion and the center electrode noble metal chip lies within a range of 0.1 mm² to 0.6 mm².

The spark gap has a length G between the top end surfaces of the ground electrode noble metal chip and the center electrode noble metal chip. The minimum sectional area portion has a length h in the lengthwise direction of the spark plug. The lengths G and h are determined to meet relations of G≧0.5 mm and G+h≧0.8 mm. This minimizes the obstruction of the ground electrode noble metal chip to the growth of the flame kernel in the spark gap to provide the higher degree of ignitability of the fuel.

The length of the minimum sectional area portion may be 0.2 mm or more.

The ground electrode noble metal chip has a second sectional area portion that is one of the plurality of portions located adjacent the minimum sectional area portion. The second sectional area portion having a sectional area of 1.13 mm² or less.

The minimum sectional area portion has a length in the lengthwise direction of the spark plug which is 0.8 mm or less.

The second sectional area portion may have a sectional area greater than that of the center electrode noble metal chip.

The ground electrode noble metal chip has at least a tapered top portion.

Each of areas of the top end surface of the ground electrode noble metal chip and a sectional area of the center electrode noble metal chip lies within a range of 0.1 mm² to 0.6 mm².

When the length G is less than 0.6 mm, the angle θ1 meets a relation of θ1≦{100+200 (G−0.5 mm)}°. When the length G is greater than or equal to 0.6 mm, the angle θ1 is 120° or less.

The angle θ1 may be 100° or less, thereby decreasing a loss of the flame on being cooled to ensure the higher degree of ignitability of fuel.

The ground electrode noble metal chip is made up of the tapered top portion and a base portion connected to the ground electrode. The base portion has a sectional area of 0.95 mm² or less.

The angle θ1 may be 20° or more, thereby keeping a rise in voltage required by the spark plug to discharge low to prolong the service life of the spark plug.

At least one of the ground electrode noble metal chip and the center electrode noble metal chip is laser-welded to a corresponding one of the ground electrode and the center electrode.

The center electrode noble metal chip is made of one of a noble metal and a noble metal alloy which has a melting point of 1900° C. or more. The ground electrode noble metal chip is made of one of a noble metal and a noble metal alloy which has a melting point of 1700° C. or more.

The center electrode noble metal chip is made from alloy containing 50% or more by weight of one of Ir, Rh, and Ru. The ground electrode noble metal chip is made from alloy containing 50% or more by weight of one of Pt and Rh.

The ground electrode noble metal chip is joined to the ground electrode through a member which has a coefficient of linear expansion intermediate between those of the ground electrode noble metal chip and the ground electrode, thereby decreasing the thermal stress acting between the ground electrode noble metal chip and the ground electrode to improve the reliability of the joint therebetween.

The length of the spark gap may be in a range of 1.2 mm or less.

According to the second aspect of the invention, there is provided a spark plug having a length for an internal combustion engine which comprises: (a) a ground electrode having a center electrode facing surface; (b) a center electrode having a ground electrode facing surface; (c) a ground electrode noble metal chip having a top portion and a base portion, the ground electrode noble metal chip being joined at the base portion to the center electrode facing surface of the ground electrode; and (d) a center electrode noble metal chip joined to the ground electrode facing surface of the center electrode to define a spark gap between itself and the ground electrode noble metal chip.

The ground electrode noble metal chip has a length, as extending from the center electrode facing surface in a lengthwise direction of the spark plug, which is 0.3 mm or more.

At least the base portion tapers toward the top portion.

The ground electrode noble metal chip is joined at the tapered base portion to the center electrode facing surface of the ground electrode through a laser welding-fused portion.

Specifically, the formation of the tapered base portion causes the top portion of the ground electrode noble metal chip to be thin, thereby, as described above, minimizing obstruction to the growth of a flame kernel in the spark gap to ensure the higher degree of ignitability of fuel and keeping the voltage required by the spark plug to discharge at lower levels.

The tapered base portion serves to minimize the formation of a dimple in the weld between the ground electrode noble metal chip and the ground electrode which arises from the laser-welding, thereby ensuring the conductivity of heat to the ground electrode to minimize the wear of the ground electrode noble metal chip. This decreases the rate of increase in size of the spark gap to keep the voltage required by the spark plug to discharge at lower levels.

The noble metal chip projects from the center electrode facing surface of the ground electrode by 0.3 mm or more, thereby enhancing the above described improvement of the ignitability of the fuel.

In the preferred mode of the invention, the top portion of the ground electrode noble metal chip has a top end surface facing the center electrode noble metal chip. An area of the top end surface and a sectional area of the center electrode noble metal chip lies within a range of 0.1 mm² to 0.6 mm².

Lines which are defined to extend along a peripheral surface of the tapered base portion and opposed diametrically across an axial center of the tapered base portion make an angle with each other which is 7° or more, thereby minimizing the formation of a dimple in the weld between the noble metal chip and the ground electrode which arises from the laser-welding, thereby ensuring the conductivity of heat to the ground electrode.

At least of one of the ground electrode noble metal chip and the center electrode noble metal chip is of a frustro-conical shape. In a case where a laser beam is emitted to weld the ground electrode noble metal chip to the ground electrode while rotating the ground electrode noble metal chip, the focus of the laser beams may be kept constant around the periphery of the ground electrode noble metal chip, thus resulting in uniformity of the weld around the whole of a circumference of the ground electrode noble metal chip.

The spark gap has a length G defined between the ground electrode noble metal chip and the center electrode noble metal chip. The angle which lines defined to extend along the peripheral surface of the tapered base portion and opposed diametrically across the axial center of the tapered base portion makes with each other is defined as θ2. The length G is greater than or equal to 0.5 mm. When the length G is less than 0.6 mm, the angle θ2 meets a relation of θ2≦{100+200 (G−0.5 mm)}°. When the length G is greater than or equal to 0.6 mm, the angle θ2 is 120° or less.

The angle θ2 may be 100° or less, thereby decreasing a loss of the flame on being cooled to ensure the higher degree of ignitability of fuel.

The angle θ2 may be 20° or more, thereby keeping a rise in voltage required by the spark plug to discharge low to prolong the service life of the spark plug.

The center electrode noble metal chip is made of one of a noble metal and a noble metal alloy which has a melting point of 1900° C. or more. The ground electrode noble metal chip is made of one of a noble metal and a noble metal alloy which has a melting point of 1700° C. or more.

The center electrode noble metal chip is made from alloy containing 50% or more by weight of one of Ir, Rh, and Ru. The ground electrode noble metal chip is made from alloy containing 50% or more by weight of one of Pt and Rh.

The ground electrode noble metal chip is joined to the ground electrode through a member which has a coefficient of linear expansion intermediate between those of the ground electrode noble metal chip and the ground electrode, thereby decreasing the thermal stress acting between the ground electrode noble metal chip and the ground electrode to improve the reliability of the joint therebetween.

The length G of the spark gap may be 1.2 mm or less.

According to the third aspect of the invention, there is provided a method of producing a spark plug for an internal combustion engine which comprises: (a) preparing a ground electrode and a center electrode, the ground electrode having a center electrode facing surface, the center electrode having a ground electrode facing surface; (b) preparing a noble metal chip which includes a top portion and a base portion and has a length of 0.3 mm or more extending from the center electrode facing surface, at least the base portion tapering toward an end of the top portion to have a sectional area decreasing as approaching the end of the top portion; (c) placing the noble metal chip at the base portion on the center electrode facing surface of the ground electrode; and (d) radiating a laser beam to an interface between the base portion of the noble metal chip and the center electrode facing surface of the ground electrode to joint the noble metal chip to the ground electrode.

Specifically, the noble metal chip has the portion tapering toward the top end thereof, in other words, the noble metal chip is made up of a thin top portion and a thick base portion joined to the ground electrode, thereby ensuring the higher degree of ignitability of fuel, as described above, and keeping the voltage required by the spark plug to discharge at lower levels.

The tapered base portion serves to minimize the formation of a dimple in the weld between the noble metal chip and the ground electrode which arises from the laser-welding, thereby ensuring the conductivity of heat to the ground electrode to minimize the wear of the noble metal chip. This decreases the rate of increase in size of the spark gap to keep the voltage required by the spark plug to discharge at lower levels. The minimization of the formation of the dimple in the weld between the noble metal chip and the ground electrode ensures the mechanical strength of the weld.

The noble metal chip projects from the center electrode facing surface of the ground electrode by 0.3 mm or more, thereby enhancing the above described improvement of the ignitability of the fuel.

In the preferred mode of the invention, the laser beam is emitted to the interface at a slant angle to the center electrode facing surface of the ground electrode to form a fused portion that is made from a mixture of materials of the noble metal chip and the ground electrode, thereby resulting in uniformity of the state of the fused portion.

The laser beams may be oriented substantially perpendicular to a peripheral surface of the tapered base portion.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows a spark plug according to the first embodiment of the invention;

FIG. 2 is a partially side view which shows a top portion of the spark plug of FIG. 1;

FIG. 3 is a partially side view which shows a top portion of a spark plug according to the second embodiment of the invention;

FIG. 4 is a partially side view which shows a top portion of a prior art spark plug;

FIG. 5 is a graph which represents relations, as derived by tests, between voltage required by spark plugs, as illustrated in FIGS. 2, 3, and 4, and a running distance of an engine;

FIG. 6 is a graph which represents relations, as derived by tests, between a change in size of a spark gap of spark plugs, as illustrated in FIGS. 2, 3, and 4, and a running distance of an engine;

FIG. 7 is a graph which represents relations, as derived by tests, between an amount of wear of a noble metal chip of a spark gap of spark plugs, as illustrated in FIGS. 2, 3, and 4, and a running distance of an engine.

FIG. 8 is an explanatory view which specifies definition of dimensions of a spark gap and amounts of wear of noble metal chips;

FIG. 9 is a graph which represents a relation, as derived by tests, between the size or length of a spark gap of the spark plug of FIG. 2 and the percentage of a cycle-by-cycle variation in combustion of fuel in an engine;

FIG. 10 is a graph which represents relations, as derived by tests, between the percentage of a cycle-by-cycle variation in combustion of fuel in an engine and the length of a noble metal chip on a ground electrode of each of a spark plug of FIG. 2 and a comparative spark plug of FIG. 4;

FIG. 11 is a graph which represents relations, as derived by tests, between the percentage of a cycle-by-cycle variation in combustion of fuel in an engine and a sectional area of a second sectional area portion of a noble metal chip on a ground electrode of a spark plug of FIG. 2;

FIG. 12 is a graph which represents relations, as derived by tests, between a change in spark gap of a spark plug of FIG. 2 and a running distance of an engine;

FIG. 13 is a graph which represents relations, as derived by tests, between voltage required by a spark plug of FIG. 2 and a change in length of a noble metal chip on a ground electrode of the spark plug;

FIG. 14 is a graph which represents relations, as derived by tests, between the percentage of a cycle-by-cycle variation in combustion of fuel in an engine and the angle of inclination of a tapered surface of a noble metal chip on a ground electrode of each of a spark plug of FIG. 3 and a comparative spark plug of FIG. 4;

FIG. 15 is a graph which represents relations, as derived by tests, between the percentage of a cycle-by-cycle variation in combustion of fuel in an engine and a sectional area of a non-tapered base portion of a noble metal chip on a ground electrode of a spark plug of FIG. 3;

FIG. 16 is a graph which represents relations, as derived by tests, between voltage required by a spark plug of FIG. 3 and a change in angle of inclination of a tapered surface of a noble metal chip on a ground electrode of the spark plug of FIG. 3;

FIG. 17 is a partially side view which shows a top portion of a spark plug according to the third embodiment of the invention;

FIG. 18(a) is a top view which shows how to laser-welding a noble metal chip to a ground electrode of the spark plug of FIG. 17;

FIG. 18(b) is a side view of FIG. 18(a);

FIG. 19(a) is a top view which shows fused portions (i.e., weld nuggets) formed by laser welding, as illustrated in FIGS. 18(a) and 18(b), to establish a joint of a noble metal chip to a ground electrode;

FIG. 19(b) is a side view of FIG. 19(a);

FIGS. 20(a), 20(b), 20(c) and 20(d) are side views which illustrate modifications of how to weld a noble metal chip to a ground electrode of the spark plug of FIG. 17;

FIG. 21 is a partially side view which shows the comparative spark plug of FIG. 9 in which a noble metal chip is laser-welded to a ground electrode;

FIG. 22 is a graph which represents relations, as derived by tests, between a laser welding-caused change in sectional area of a noble metal chip of a spark plug in FIG. 17 and the angle of inclination of a tapered surface of the noble metal chip;

FIG. 23 is a partially side view which shows a noble metal chip welded to a ground electrode according to the fourth embodiment of the invention;

FIG. 24 is a partially side view which shows a modification of how to weld the noble metal chip to the ground electrode in FIG. 23;

FIGS. 25(a), 25(b), 25(c), 25(d), 25(e), and 25(f) are views which illustrate modifications of the noble metal chip for use in the spark plug in FIG. 2 or FIG. 3;

FIGS. 26(a), 26(b), and 26(c) are views which illustrate modifications of the noble metal chip for use in the spark plug in FIG. 2 or FIG. 3;

FIGS. 27(a), 27(b), FIGS. 27(c), and 27(d) are views which illustrate modifications of the noble metal chip for use in the spark plug in FIG. 2 or FIG. 3;

FIG. 28 is a partially side view which shows a top portion of a spark plug according to the fifth embodiment of the invention;

FIG. 29 is a partially side view which shows a top portion of a spark plug according to the sixth embodiment of the invention;

FIGS. 30(a), 30(b), FIGS. 30(c), and 30(d) are views which illustrate modifications of the noble metal chip on the ground electrode, as illustrated in FIGS. 17 to 20(d), in the third embodiment; and

FIGS. 31(a) and 31(b) are views which illustrate other modifications of the noble metal chip on the ground electrode, as illustrated in FIGS. 17 to 20(d), in the third embodiment.

### DESCRIPTION OF THE PREFERRED EMBODIMENTS

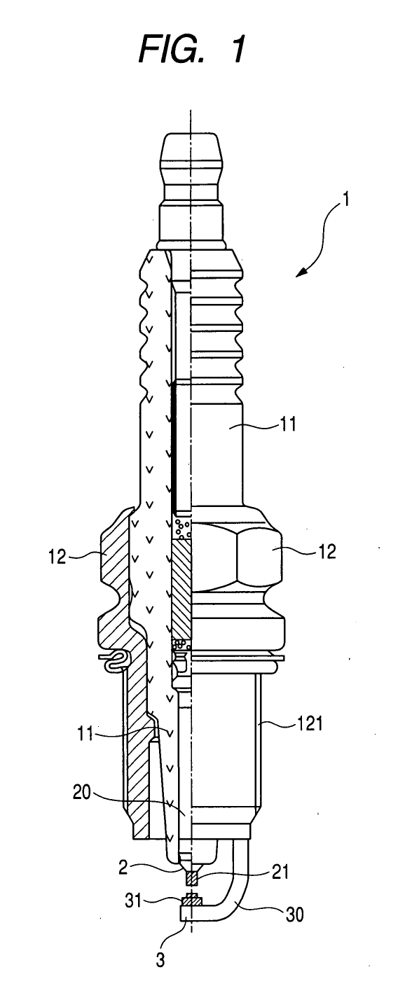

Referring now to the drawings, particularly to FIGS. 1 and 2, there is shown a spark plug 1 for internal combustion engines according to the first embodiment of the invention which may be employed in automotive vehicles, cogeneration systems, or gas feed pumps.

The spark plug 1 includes a center electrode 2, a ground electrode 3, a porcelain insulator 11, and a metal shell 12. The center electrode 2 and the ground electrode 3 are opposed to each other to define a spark gap (also called an air gap) therebetween. The center electrode 2 and the ground electrode 3 have faces which are opposed to each other and to which a noble metal chip (will also be referred to as a center electrode chip below) 21 and a noble metal chip (will also be referred to as a ground electrode chip below) 31 are affixed, respectively.

A ground electrode body 30 extends from an end of the metal shell 12 to form the ground electrode 3. A center electrode body 20 extends from the porcelain insulator 11 and has a head projecting from the end of the porcelain insulator 11 to form the center electrode 2. The ground electrode chip 31 projects from the outer surface (i.e., a center electrode facing surface) of the ground electrode body 30 by 0.3 mm or more. Specifically, the amount of projection H (i.e., the length extending in a longitudinal direction of the spark plug 1), as illustrated in FIG. 2, of the ground electrode chip 31 is 0.3 mm or more (H≧0.3 mm).

The ground electrode chip 31 has a portion whose sectional area extending perpendicular to a longitudinal center line thereof (i.e., an axial direction of the spark plug 1) is greater than that of a top end surface 311. Specifically, the ground electrode chip 31 is made up of a plurality of portions whose sectional areas extending perpendicular to the axial direction thereof are different from each other. One of the portions which is the smallest in sectional area (i.e., diameter) is the top end portion which will be referred to below as a minimum sectional area portion 312. More specifically, the ground electrode chip 31 is made up of the minimum sectional area portion 312 and a second sectional area portion 313 joined to the ground electrode body 30. The second sectional area portion 313 is greater in sectional area (i.e., diameter) than the minimum sectional area portion 312.

The porcelain insulator 11, as clearly illustrated in FIG. 1, has retained therein the center electrode 2 with the top end thereof projecting from outside the top end or nose of the porcelain insulator 11. The porcelain insulator 11 is installed inside the metal shell 12. The metal shell 12 has a plug-installation thread 121 formed on an outer periphery thereof for installing the spark plug 1 in the engine. The ground electrode body 30 is welded to the top end of the metal shell 12 and bent at approximately right angles to have a middle portion facing the center electrode 2 in a radius direction of the porcelain insulator 11 (i.e., the spark plug 1).

The center electrode chip 21 is cylindrical. The ground electrode chip 31 is, as described above, made up of the minimum sectional area portion 312 and the second sectional area portion 313 which are joined coaxially in alignment with the longitudinal center line of the spark plug 1.

The sectional areas of the minimum sectional area portion 312 of the ground electrode chip 31 and the center electrode chip 21 are each between 0.1 mm² to 0.6 mm².

The size or length G of the spark gap and the length h of the minimum sectional area portion 312 of the ground electrode chip 31 in the longitudinal direction of the spark plug 1, as clearly illustrated in FIG. 2, have dimensions and a relation below.
1.2 mm≧G≧0.5 mm, G+h≧0.8 mm, 0.2 mm≧0.8 mm

The second sectional area portion 313 of the ground electrode chip 31 has a transverse sectional area of 1.13 mm² or less which is greater than that of the center electrode chip 21.

The center electrode chip 21 and the ground electrode chip 31 are laser-welded to the center electrode body 20 and the ground electrode body 30, respectively.

The center electrode chip 21 is made from alloy containing 50% or more by weight of one of Ir, Rh, and Ru. The ground electrode chip 31 is made from alloy containing 50% or more by weight of one of Pt and Rh. The center electrode chip 21 has a melting point of 1900° C. or more. The ground electrode chip 31 has a melting point of 1700° C. or more.

The advantages, as provided by the structure of the spark plug 1, will be described below.

The ground electrode chip 31 is, as described above with reference to FIG. 2, made up of the second sectional area portion 313 joined to the face of the ground electrode body 30 and the minimum sectional area portion 312 placed on the second sectional area portion 313 to define the top end closer to the center electrode chip 21. The second sectional area portion 313 is greater in sectional area than the minimum sectional area portion 312, thereby ensuring a higher degree of ignitability of an air-fuel mixture and keeping the rate of increase in voltage required by the spark plug 1 to discharge across the spark gap low.

Specifically, the ground electrode chip 31 has a thinner top end portion (i.e., the minimum sectional area portion 312), thereby minimizing the obstruction of the ground electrode chip 31 to the growth of a flame kernel in the spark gap to ensure the higher degree of ignitability of the mixture. The ground electrode chip 31 has also a thicker base end portion (i.e., the second sectional area portion 313), thereby minimizing the amount of wear of the ground electrode chip 31 per unit time in the longitudinal direction thereof. This minimizes an undesirable increase in size or length of the spark gap and decreases the rate of a rise in the required voltage, thus resulting in an increase in service life of the spark plug 1.

When the whole of the minimum sectional area portion 312 is worn out, it will cause the second sectional area portion 313 to appear as the top end of the ground electrode chip 31, thus resulting in an increase in length of the spark gap in which a sequence of sparks appear. This avoids an undesirable rise in voltage required by the spark plug 1. Before worn out, the minimum sectional area portion 312 ensures the range of the spark gap narrower in the radius direction of the spark plug 1, thus, as described above, facilitating the growth of a flame kernel in the spark gap to provide the higher degree of ignitability of the mixture.

The ground electrode chip 31 projects from the surface of the ground electrode body 30 by 0.3 mm or more (H≧0.3 mm), thereby enhancing the above described improvement of the ignitability of the fuel.

The sectional areas of the minimum sectional area portion 312 of the ground electrode chip 31 and the center electrode chip 21 are each between 0.1 mm² to 0.6 mm², thereby ensuring a higher degree of the ignitability of fuel and decreasing the rate of increase in voltage required by the spark plug 1 to discharge.

The length G of the spark gap and the length h of the minimum sectional area portion 312 of the ground electrode chip 31 meet the conditions of G≧0.5 mm and G+h≧0.8 mm, thereby ensuring the higher degree of the ignitability of fuel.

The length G also meets the condition of G≦1.2 mm, thereby keeping the voltage required by the spark plug 1 at a lower level within an allowable voltage range even when the edge of the ground electrode noble metal chip 13 is worn at an initial stage where the spark gap hardly increase and also minimizing a rise in the required voltage to keep it within the allowable voltage range when the spark gap increases undesirably.

The length h of the minimum sectional area portion 312 of the ground electrode chip 31 is 0.2 mm or more, thereby ensuring the higher degree of the ignitability of fuel, while it is also 0.8 mm or less, thereby keeping the required voltage low to achieve the increasing of the service life of the spark plug 1.

The second sectional area portion 313 of the ground electrode chip 31 has a sectional area of 1.13 mm² or less, thereby ensuring the higher degree of the ignitability of fuel. The sectional area is greater than that of the center electrode chip 21, thereby ensuring the increase in range in which a sequence of sparks appear after the whole of the minimum sectional area portion 312 is worn out, which avoids an undesirable rise in voltage required by the spark plug 1.

The center electrode chip 21 is laser-welded to the center electrode body 20, thereby resulting in formation of a fused portion(s) therebetween which is made of materials thereof melted together. The fused portion has a coefficient of linear expansion intermediate between those of the center electrode chip 21 and the center electrode body 20 and results in a decrease in thermal stress appearing therebetween to improve the reliability of joining of the center electrode chip 21 to the center electrode body 20. The same is true for the ground electrode chip 31.

The center electrode chip 21 has a melting point of 1900° C. or more, while the ground electrode chip 31 has a melting point of 1700° C. or more, thus resulting in a decrease in wear thereof to ensure the service life of the spark plug 1. Particularly, the center electrode chip 21 that is typically used as a negative electrode and apt to be melted and consumed by sparks, resulting in an increase in amount of the wear thereof, is higher in melting point than the ground electrode chip 31, thereby enhancing the increase in service life of the spark plug 1.

The center electrode chip 21 is made from alloy containing 50% or more by weight of one of Ir, Rh, and Ru, while the ground electrode chip 31 is made from alloy containing 50% or more by weight of one of Pt and Rh, thereby resulting in a decrease in wear thereof to ensure the service life of the spark plug 1. Specifically, the center electrode chip 21 that is apt to be melted and consumed by sparks contains 50% or more by weight of one of Ir, Rh, and Ru, while the ground electrode chip 31 that is greater in resistance to high-temperature oxidation and volatilization contains 50% or more by weight of one of Pt and Rh, thus enhancing the increase in service life thereof.

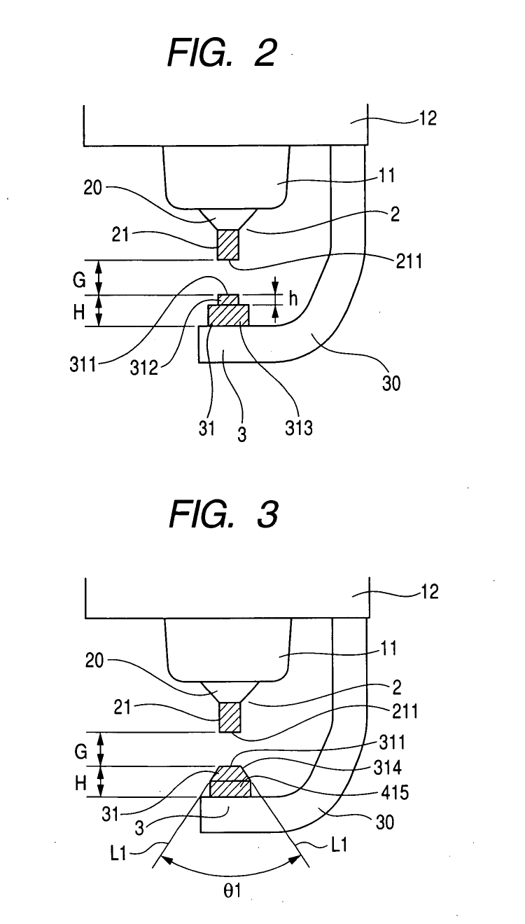

FIG. 3 shows the spark plug 1 according to the second embodiment of the invention.

The ground electrode chip 31 is made up of a frusto-conical portion 311 with an annular tapered surface and a cylindrical base portion 415. The frusto-conical portion 311 has the top end surface 311 which extends perpendicular to the longitudinal direction of the spark plug 1 and has an area of 0.1 mm² to 0.6 mm². The sectional area of the center electrode chip 21 is also within a range of 0.1 mm² to 0.6 mm².

The length G of the spark gap between the top end surfaces 211 and 311 is greater than or equal to 0.5 mm (G≧0.5 mm). When G<0.6 mm, an angle θ1, as clearly illustrated in FIG. 3, which lines L1 make with each other is preferably selected to meet a relation of θ1≦{100+200 (G−0.5 mm)}. The lines L1 are defined to extend along the tapered surface of the frusto-conical portion 314 and be opposed diametrically to each other across the center of the top end surface 311. When G≧0.6 mm, the angle θ1 is preferably selected to be 120° or less. The angle θ1 is more preferably to meet a relation of 20°≦θ1≦100°.

The cylindrical base portion 415 of the ground electrode chip 31 has a transverse sectional area of 0.95 mm² or less.

Other arrangements of the spark plug 1 are identical with those in the first embodiment, and explanation thereof in detail will be omitted here.

The frusto-conical portion 314 of the ground electrode chip 31 serves to ensure a higher degree of ignitability of fuel in the spark plug 1 and decrease the rate of increase in voltage required by the spark plug 1 to provide an increased service life of the spark plug 1.

Specifically, as the frusto-conical portion 314 is worn during use of the spark plug 1, it will cause the area of the top end surface 311 of the ground electrode chip 31 to increase gradually, thus resulting in a decrease in rate at which the spark gap, i.e., the distance between the center electrode chip 21 and the ground electrode chip 31 increases undesirably, thereby avoiding an undesirable rise in voltage required by the spark plug 1. Additionally, the increase in area of the top end surface 311 of the ground electrode chip 31 will also result in an increase in range in which a sequence of sparks are to appear, thereby keeping the required voltage low.

The area of the frusto-conical portion 311 of the ground electrode chip 31 and the sectional area of the center electrode chip 21 are between 0.1 mm² to 0.6 mm², thereby ensuing the higher degree of the ignitability of fuel and a decrease in the voltage required by the spark plug 1.

The length G of the spark gap is selected to be greater than or equal to 0.5 mm (G≧0.5 mm). When G<0.6 mm, the angle θ1, as can be seen in FIG. 3, is selected to meet the relation of θ1≦{100+200 (G−0.5 mm)}. When G≧0.6 mm, the angle θ1 is selected to meet a relation of θ1<120°. This ensures the higher degree of the ignitability of fuel.

Additionally, the angle θ1 may be selected to be 100° or less to improve the ignitability of fuel and 20° or more to minimize an undesirable rise in the required voltage to increase the service life of the spark plug 1.

The cylindrical base portion 415 of the ground electrode chip 31 has a sectional area of 0.95 mm² or less, thereby improving the ignitability of fuel.

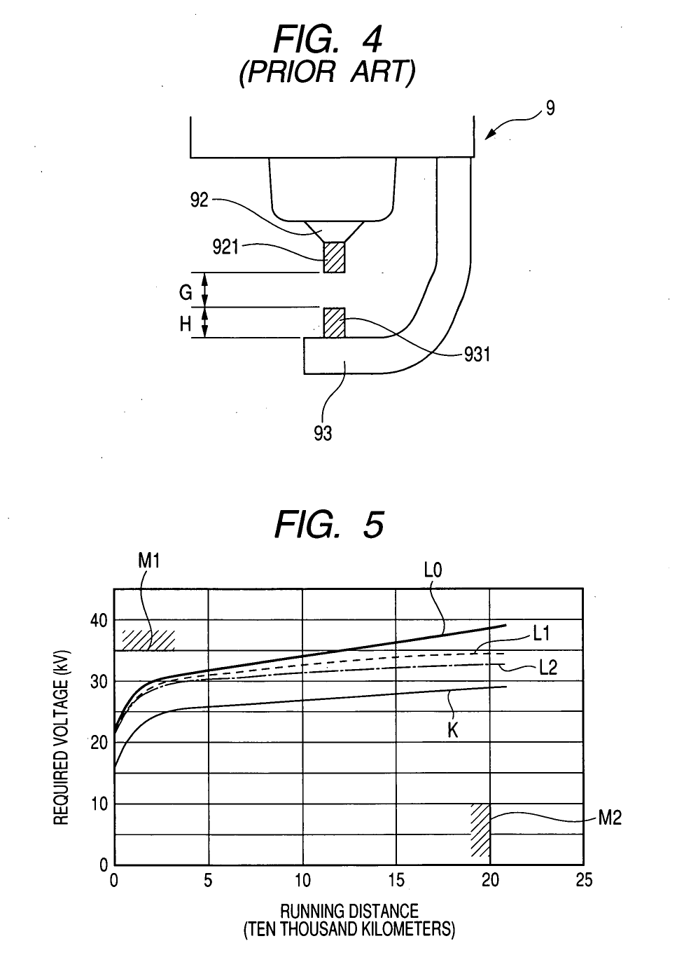

FIG. 4 illustrates a comparative example of a spark plug 9 for internal combustion engines which is equipped with noble metal chips 921 and 931 welded to a center electrode 92 and a ground electrode 93. The noble metal chips 921 and 931 are each made of a cylindrical straight bar. Other arrangements are identical with those in the first embodiment.

In order to facilitate the growth of a flame kernel to ensure the higher degree of ignitability of fuel, the spark plug 9 may be designed to decrease sectional areas of the noble metal chips 921 and 931. The thinning of the noble metal chips 921 and 931, as described above however, may result in a rapid increase in the spark gap caused by the wear of the noble metal chips 921 and 931, which leads to a rise in voltage required by the spark plug 9 to discharge and a decrease in service life of the spark plug 9.

The thinning of the noble metal chip 931 of the ground electrode 93 that is a positive electrode gives rise to the problem that the range in which a sequence of sparks appear increases undesirably.

Each of the spark plugs 1 of the first and second embodiments is designed to have at least one of the center electrode chip 21 and the ground electrode chip 31 shaped to have a portion whose sectional area, as extending in the radius direction thereof, is greater than a corresponding one of the top surfaces 211 and 311, thereby ensuring the ignitability of fuel and minimizing a rise in voltage required by the spark plug 1 to increase the service life of the spark plug 1.

The inventor performed durability tests on the spark plugs 1 of the first and second embodiment and the spark plug 9, as illustrated in FIG. 4.

The inventor prepared a spark plug test sample No. 1 identical in structure with the spark plug 1 in FIG. 2. In the spark plug test sample No. 1, the sectional area of the center electrode chip 21 was 0.24 mm². The sectional area of the minimum sectional area portion 312 of the ground electrode chip 31 was 0.24 mm². The sectional area of the second sectional area portion 313 was 0.79 mm². The length H of the ground electrode chip 31 was 1.0 mm. The length G of the spark gap was 0.8 mm. The length h of the minimum sectional area portion 312 was 0.3 mm. The inventor also prepared a spark plug test sample No. 2 identical in structure with the spark plug 1 in FIG. 3. In the spark plug test sample No. 2, the sectional area of the center electrode chip 21 was 0.24 mm². The area of the top end surface 311 of the ground electrode chip 31 was 0.24 mm². The sectional area of the cylindrical base portion 415 was 0.79 mm². The length H of the ground electrode chip 31 was 1.0 mm. The length G of the spark gap was 0.8 mm. The angle θ1 of the inclination of the tapered surface of the frusto-conical portion 314 of the ground electrode chip 31 was 90°

The inventor further a prepared comparative spark plug test sample identical in structure with the one in FIG. 4. In the comparative spark plug test sample, the sectional area of the noble metal chip 921 of the center electrode 92 was 0.24 mm². The sectional area of the noble metal chip 931 of the ground electrode 93 was also 0.24 mm². The length H of the noble metal chip 931 was 1.0 mm. The length G of the spark gap was 0.8 mm.

The tests were accomplished by installing each of the above test samples in each of a normal automotive 1600 cc four-cylinder normal aspiration engine and a automotive supercharged high-compression ratio 1600 cc four-cylinder engine equipped with a supercharger and measuring a change in voltage required by the test sample to discharge during running of the engine. Such a measurement was made by placing each of the engines on a test bench, running it according to a durability pattern simulating urban driving conditions where the highest voltage is required to discharge, and sampling the required voltage at given time intervals.

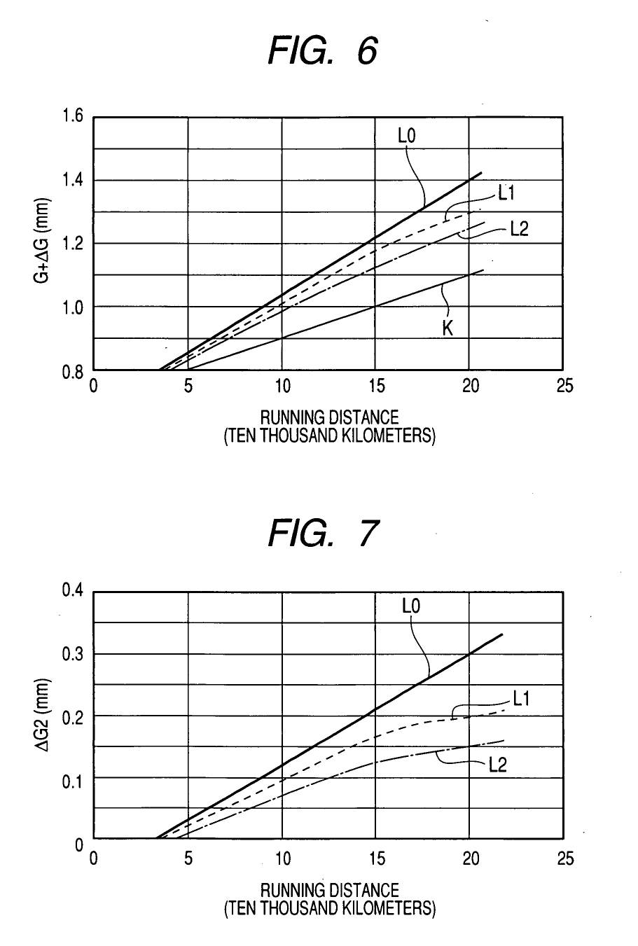

Results of the durability tests are shown in a graph of FIG. 5. A curve K represents a change in the required voltage in the comparative spark plug sample installed in the former normal engine. Curves L0, L1, and L2 represent changes in the required voltage in the comparative spark plug test sample and the spark plug test samples Nos. 1 and 2 installed in the supercharged high-compression ratio engine. The same is true for graphs of FIGS. 6 and 7. In the graph of FIG. 5, a line M1 represents an allowable limit (35 kV) of the required voltage. A line M2 represents a target service life (e.g., 200,000 km) of the spark plug.

The inventor also measured a change in the spark gap (G+ [symbol] G) in each of the test samples during the durability tests. Results of such measurements are shown in FIG. 6. G indicates an initial length of the spark gap. [symbol] G indicates an increase in the spark gap.

The inventor also measured the amount of wear [symbol] G2 of the noble metal chip 31 of the ground electrode 3 in each of the test samples installed in the supercharged high-compression ratio engine. Results of such measurements are shown in FIG. 7.

The definitions of the length G of the spark gap and the amounts of wear [symbol] G1 and [symbol] G2 of the noble metal chips 21 and 31, as referred to herein, are given as illustrated in FIG. 8. Note that [symbol] G= [symbol] G1+ [symbol] G2.

The typical process of reaching the service life of the spark plug 1 will be discussed below.

In the mint-condition, the noble metal chip 21 of the center electrode 2 has a sharp edge, so that the required voltage is low. This is because the electric field usually concentrates at the edge of the noble metal chip 21. The noble metal chips 21 and 31 are initially consumed or worn from the edges thereof by sparks, thus causing the required voltage to rise rapidly (see FIG. 5) at an initial stage where the running distance is shorter. The spark gap (G+ [symbol] G) hardly changes, as demonstrated in FIG. 6.

Afterwards, the noble metal chips 21 and 31 are worn substantially parallel to the top surfaces 211 and 311 thereof, so that the spark gas increases, and the required voltage rises gradually. When the required voltage exceeds the allowable limit, the service life of the spark plug 1 is viewed to be reached. The allowable limit is generally determined as a function of the voltage, as developed by the ignition coil, and the dielectric strength of the porcelain insulator 11.

The graph of FIG. 5 shows that the voltage required by the comparative spark plug test sample after the normal engine runs 200 thousand kilometers that is the target service life (i.e., line M2) usually required for maintenance-free spark plugs is lower than the allowable limit (i.e., line M1), however, it exceeds the allowable limit after the supercharged high-compression ratio engine runs approximately 120 to 130 thousand kilometers, meaning that the service life greatly drops.

The graph of FIG. 5 also shows that the voltage required by each of the spark plug test samples Nos. 1 and 2 after the supercharged high-compression ratio engine runs 200 thousand kilometers is lower than the allowable limit, that is, that the geometrical structure of the noble metal chip 31 of the ground electrode 3 of the spark plug 1 results in a decreased rise in the required voltage and an increase in service life even in the case of use in the supercharged high-compression ratio engine. Of course, although not specified in the graph of FIG. 5, the structure of the spark plug 1 serves to decrease the rise in the required voltage and ensure the service life in the case of use in the normal engine.

The reasons whey the structures of the spark plug test samples Nos. 1 and 2 serve to decrease the rise in the required voltage will be described below.

The test sample No. 1 is higher in thermal conductivity of the noble metal chip 31 of the ground electrode 3 than the comparative spark plug test sample, thereby resulting, as can be seen from FIG. 7, in a decrease in the amount of wear [symbol] G2 of the noble metal chip 31 to keep, as can be seen from FIG. 6, the increase in the spark gap [symbol] G low and decrease the rise in the required voltage. The spark plug test sample No. 1, as can be seen from FIG. 7, decreases in the rate at which the spark gap increases after the engine runs approximately 150 thousand kilometers. This is because most of the minimum sectional area portion 312 of the noble metal chip 31 of the ground electrode 3 has been worn out, so that a sequence of sparks appear on the second sectional area portion 313 as well as the minimum sectional area portion 312, thus resulting in a decrease in number of spark discharges per unit time (i.e., per unit of the travel distance) on the minimum sectional area portion 312, that is, a decrease in amount of wear of the minimum sectional area portion 312 per unit time. Additionally, when the minimum sectional area portion 312 is worn out, it will, as described above, result in an increase in range in which a sequence of sparks appear, thereby further keeping the rise in the required voltage low.

The spark plug test sample No. 2 is not only much higher in terms of the thermal conductivity of the noble metal chip 31 of the ground electrode 3 than the comparative spark plug test sample, but also has the sectional area of the noble metal chip 31 increasing with an increase in the running distance of the engine (i.e., the amount of wear thereof, thus resulting, as can be seen from FIG. 7, in a greater decrease in the amount of wear [symbol] G2 of the noble metal chip 31, which decreases, as shown in FIG. 6, the rate of increase [symbol] G in the spark gap, thereby keeping the required voltage low. Additionally, the range in which a sequence of sparks appear increases with an increase in the running distance of the engine, thus further keeping the rise in the required voltage low.

When, although not illustrated, the noble metal chip 931 of the ground electrode 93 of the comparative spark plug test sample is designed to have the sectional area increased to be identical with, for example, that of the second sectional area portion 313 of the spark plug test sample No. 1, it will function to keep the rise in the required voltage low, like the spark plug test samples Nos. 1 and 2, but however, have the disadvantage that the increased area of the top surface of the noble metal chip 931 obstructs the growth of a flame to increase the difficulty in keeping the ignitability of fuel high. The spark plug test samples Nos. 1 and 2 have the decreased areas of the top surfaces 311 of the noble metal chips 313 and 314, thus ensuring an increased service life of the spark plug 1 without sacrificing the ignitability of the fuel.

The inventor performed tests to search effects of the amount of projection or length H of the noble metal chip 31 of the ground electrode 3 on the ignitability of the fuel. The search was conducted by sampling cycle-by-cycle variations in combustion of fuel in the engine equipped with test samples of the spark plug 1 of the first embodiment over a sequence of 200 cycles for different values of the length H. The test samples of the spark plug 1 used in the tests had specifications below.

The sectional area of the noble metal chip 21 of the center electrode 2 was 0.24 mm². The sectional area of the minimum sectional area portion 312 of the noble metal chip 31 was 0.24 mm². The sectional area of the second sectional area portion 313 was 0.79 mm². The length G of the spark gap was 0.8 mm. The length h of the minimum sectional area portion 312 was 0.1 mm.

The tests were performed by running the above described supercharged high-compression ratio engine at an idle speed of 700 rpm. The cycle-by-cycle variations in combustion of the fuel are expressed by the percentage in a graph of FIG. 9 and given by the indicated mean effective pressure (standard deviation/average) X 100. When the percentage of the cycle-by-cycle variation in combustion was below 15%, the inventor determined the spark plug 1 as keeping the ignitability of the fuel high.

The graph of FIG. 9 shows that when the length H is less than 0.3 mm, it results in a great decrease in degree of the ignitability of fuel, that is, a great increase in the percentage of the cycle-by-cycle variation in combustion. This is because the effects of improving the ignitability of fuel, as produced by thinning the ground electrode 31, decrease.

The inventor also performed the same test, as described above, on the spark plug 1 of the first embodiment having other specifications and the spark plug 1 of the second embodiment and got the same test results.

In order to enhance the above described features of the structure of the spark plug 1, the noble metal chip 21 of the center electrode 2 may alternatively be designed to have the same structure as that of the noble metal chip 31 in either of the first and second embodiments.

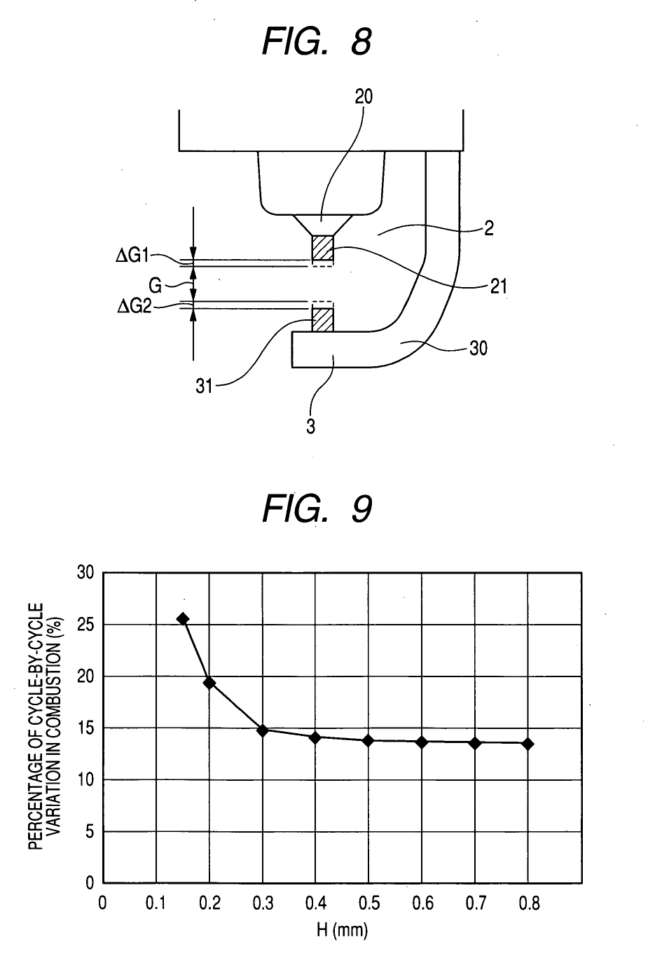

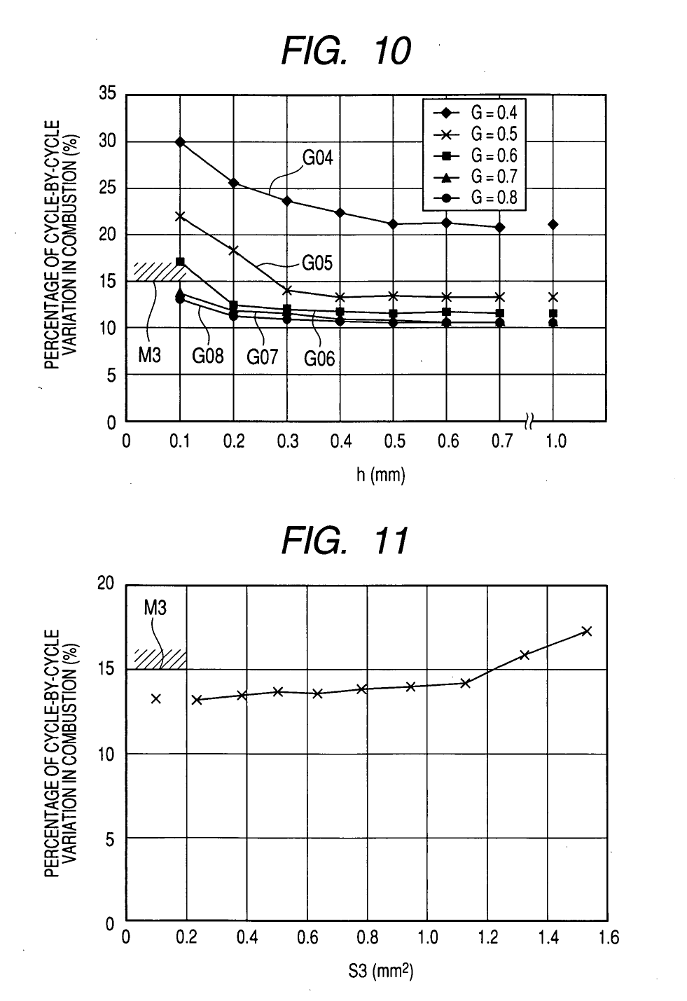

The inventor also performed tests to study the specifications of the spark plug 1 in the first embodiment. The study was conducted in terms of effects of the length G of the spark gap and the amount of projection or length h of the minimum sectional area portion 312 of the ground electrode chip 31 on the ignitability of fuel by sampling the cycle-by-cycle variations in combustion of fuel in the engine over a sequence of 200 cycles for different values, as demonstrated in FIG. 10, of the length G of the spark gap and the length h of the minimum sectional area portion 312. The sampling was made in the same manner as described in FIG. 9.

The test samples of the spark plug 1 used in the above tests had specifications below other than the length G of the spark gap and the length h of the minimum sectional area portion 312.

The sectional area of the sectional area of the noble metal chip 21 was 0.1 mm². The sectional area of the minimum sectional area portion 312 of the noble metal chip 31 was 0.1 mm². The sectional area of the second sectional area portion 313 was 1.13 mm². The length H of the noble metal chip 31 was 1.0 mm.

The inventor also prepared comparative spark plug test samples having the same structure as that of the spark plug 9 illustrated in FIG. 4 and performed the same tests, as described above, thereon. In these samples, the sectional area of the noble metal chip 921 of the center electrode 92 was 0.1 mm². The sectional area of the noble metal chip 931 of the ground electrode 93 was 0.1 mm². The length H of the noble metal chip 931 was 1.0 mm.

Results of the tests are given in a graph of FIG. 10. Curves G04, G05, G06, G07, and G08 represent percentages of the cycle-by-cycle variation in combustion of fuel for the spark plug test samples of 0.4 mm, 0.5 mm, 0.6 mm, 0.7 mm, and 0.8 mm in the length G of the spark gap. The length H of the noble metal chip 931 of the comparative spark plug test samples is expressed as the length h for the sake of convenience. Plots on one of vertical lines at which the length h is 1.01 mm represent the percentages of the cycle-by-cycle variation in combustion of fuel for the comparative spark plug test samples. A line M3 indicates an allowable limit (15%) of the cycle-by-cycle variation in combustion of fuel. The same applies to graphs of FIGS. 11, 14, and 15.

The graph of FIG. 10 shows that when the length G of the spark gap is 0.4 mm (i.e., G04), it is impossible for the comparative spark plug test sample as well as the test sample of the spark plug 1 to ensure the higher degree of ignitability of fuel, and when the length G of the spark gap is 0.5 mm or more, ones of the test samples of the spark plug 1 in which the sum of G and h is 0.8 mm or more serve to keep the ignitability of fuel high. Specifically, it is found that when the length G of the spark gap is smaller, a decrease in loss of flame on being cooled by the top end of the noble metal chip 31 of the ground electrode 3 is achieved by increasing the length h of the minimum sectional area portion 312 (e.g., when G=0.5 mm, h is selected to be 0.3 mm or more, or when G=0.6 mm, h is selected to be 0.2 mm or more) to keep the ignitability of fuel high.

The graph of FIG. 10 also shows that when h=0.1 mm, the test samples of the spark plug 1 are lower in the ignitability of fuel than the comparative spark plug test samples, when h=0.1 mm and G=0.4 mm, the test samples of the spark plug 1 are greater in the percentage of the cycle-by-cycle variation in combustion than the allowable limit M3, and when h is 0.2 mm or more, the test sample of the spark plug 1 ensure substantially the same ignitability of fuel as that of the comparative spark plug test samples. It is, thus, found that the length h of the minimum sectional area portion 312 of the ground electrode chip 31 is preferably 0.2 mm or more.

The inventor also performed tests on samples of the spark plug 1 of the first embodiment to search effects of the sectional area S3 of the second sectional area portion 313 of the ground electrode chip 31 on the ignitability of the fuel. The search was conducted by sampling the cycle-by-cycle variations in combustion of fuel in the engine equipped with the samples of the spark plug 1 in the same manner as described above. Results of the tests are shown in a graph of FIG. 11. For the sake of convenience, the graph represents only for the case a condition of G+h=0.8 mm, and G=0.5 mm which exhibits the greatest effect of the sectional area S3 on the ignitability of fuel.

The graph of FIG. 11 shows that when the sectional area S3 is greater than 1.13 mm² (i.e., a diameter of 1.2 mm), the percentage of the cycle-by-cycle variation in combustion exceeds the allowable limit M3, thus resulting in a difficulty in keeping the ignitability of fuel high. This is because the loss of flame on being cooled by the second sectional area portion 313 increases. It is, thus, found that the sectional area S3 is preferably 1.13 mm² or less to ensure the higher degree of ignitability of fuel.

The inventor also performed durability tests on samples of the spark plug 1 of the first embodiment to search a change in the spark gap (i.e., G+AG) for different values of the length h of the minimum sectional area portion 312. The tests were conducted by installing each of the test samples in the supercharged high-compression ratio engine and running it according to the same durability pattern, as described above, simulating the urban driving conditions.

The test samples of the spark plug 1 used in the above tests had the following specifications. The sectional area of the noble metal chip 21 of the center electrode 2 was 0.6 mm². The sectional area of the minimum sectional area portion 312 of the noble metal chip 31 was 0.1 mm². The sectional area of the second sectional area portion 313 was 1.13 mm². The length H of the noble metal chip 31 was 1.0 mm. An initial value of the length G of the spark gap was 0.5 mm.

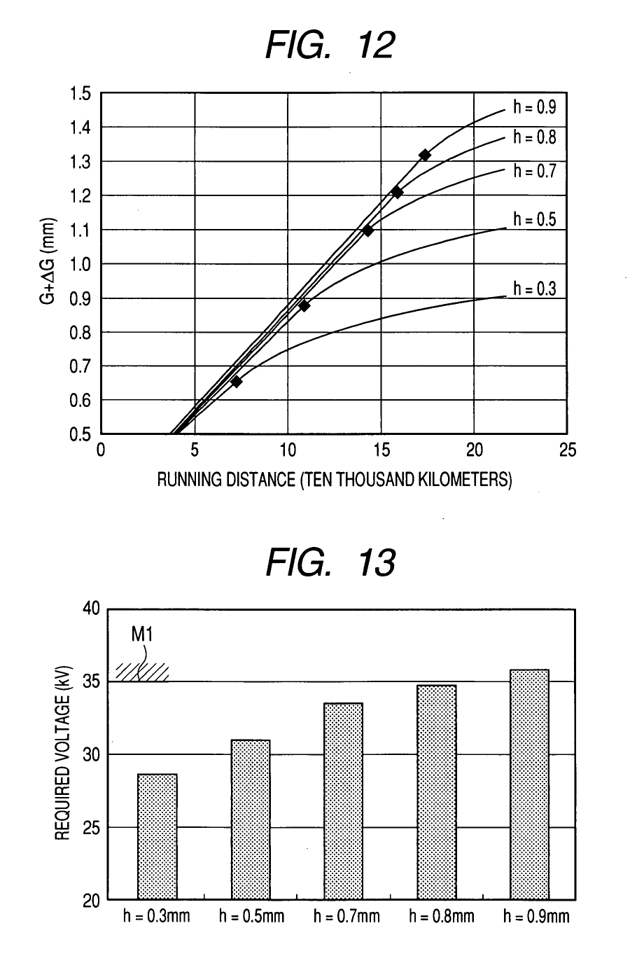

Results of the durability tests are shown in a graph of FIG. 12. “♦” indicates the time when the spark discharge started to occur on the second sectional area portion 313.

The inventor also measured voltages required by the test samples to discharge after the engine run 200 thousand kilometers. Results of such measurements are shown in a graph of FIG. 13.

The graphs of FIGS. 12 and 13 show that a decrease in the length h of the minimum sectional area portion 312 results in a decrease in rate of increase in the spark gap, thus keeping the required voltage low. This is because as the length h is smaller, the spark discharge starts to occur on the second sectional area portion 313 at an initial stage where the running distance of the engine is shorter. The graphs also show that as the length h of the minimum sectional area portion 312 increases, a greater deal of time will be consumed to exhibit the above effects, and when the length h is greater than 0.8 mm, the required voltage exceeds the allowable limit M1 after the engine runs 200 thousand kilometers. It is, thus, found that the length h is preferably 0.8 mm or less to increase the service life of the spark plug 1.

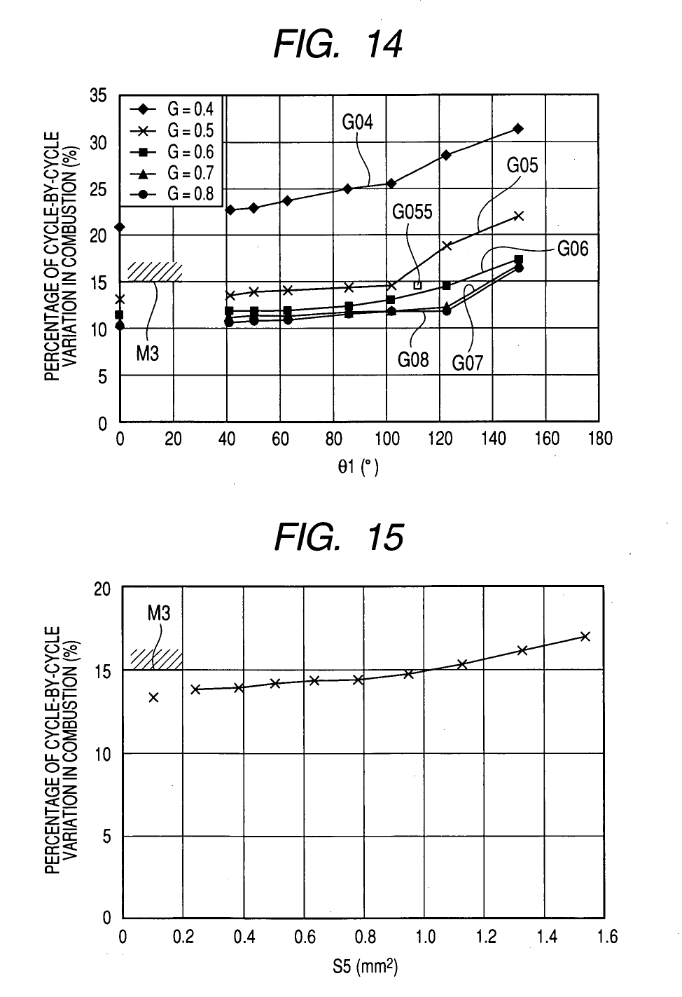

The inventor also prepared samples of the spark plug 1 of the second embodiment, as illustrate in FIG. 3, and performed tests to study the specifications of the spark plug 1. The study was conducted in terms of effects of the length G of the spark gap and the angle θ1 of the inclination of the tapered surface of the frusto-conical portion 314 of the noble metal chip 31 of the ground electrode 3 on the ignitability of fuel by sampling the cycle-by-cycle variations in combustion of fuel in the engine over a sequence of 200 cycles for different values, as demonstrated in FIG. 14, of the length G of the spark gap and the angle θ1 of the frusto-conical portion 314 in the same manner as described above.

The samples of the spark plug 1 used in the above tests had specifications below other than the length G of the spark gap and the angle θ1 of the frusto-conical portion 314.

The sectional area of the noble metal chip 21 of the center electrode 2 was 0.1 mm². The area of the top end surface 311 of the noble metal chip 31 was 0.1 mm². The sectional area of the cylindrical base portion 415 of the ground electrode 3 was 0.95 mm². The length H of the noble metal chip 31 was 1.0 mm.

The inventor also prepared comparative spark plug test samples having the same structure as that of the spark plug 9 illustrated in FIG. 4 and performed the same tests, as described above, thereon. In the samples, the sectional area of the noble metal chip 921 of the center electrode 92 was 0.1 mm². The sectional area of the noble metal chip 931 of the ground electrode 93 was 0.1 mm². The length H of the noble metal chip 931 was 1.0 mm.

Results of the tests are given in a graph of FIG. 14. Curves G04, G05, G06, G07, and G08 represent percentages of the cycle-by-cycle variation in combustion of fuel for the spark plug test samples of 0.4 mm, 0.5 mm, 0.6 mm, 0.7 mm, and 0.8 mm in the length G of the spark gap. Plots on one of vertical lines at which the angle θ1 is zero (0) represent the percentages of the cycle-by-cycle variation in combustion of fuel for the comparative spark plug test samples.

The graph of FIG. 14 shows that when the length G of the spark gap is 0.4 mm (i.e., G04), it is impossible for the comparative spark plug test sample as well as the test sample of the spark plug 1 to ensure the higher degree of ignitability of fuel and that ones of the test samples of the spark plug 1 in which the length G of the spark gap is 0.5 mm, and the angle θ1 is 100° or less and in which the length G of the spark gap is 0.6 mm or more, and the angle θ1 is 120° or less serve to keep the ignitability of fuel high. This is because a decrease in the angle θ1 of the frusto-conical portion 314 serves to decrease the loss of flame on being cooled by the top end of the noble metal chip 31 of the ground electrode 3.

It is, thus, found that when 0.5 mm≦G<0.6 mm, or 0.6 mm≦G, the ignitability of fuel is kept high by selecting the angle θ1 to meet the relation of θ1≦{100+200(G−0.5 mm)}° or θ1≦120°, respectively. Note that when 0.5 mm≦G<0.6 mm, the relation of θ1≦{100+200 (G−0.5 mm)}° was derived by analyzing the percentage of the cycle-by-cycle variation in combustion (i.e., G05 in FIG. 14) when G=0.55 mm, and θ1=112°.

It is appreciated from the graph of FIG. 14 that when 0.5 mm≦G, the angle θ1 is preferably selected to be 100° or less in terms of keeping the ignitability of fuel high.

The inventor also performed tests on samples of the spark plug 1 of the second embodiment to search effects of the sectional area S5 of the cylindrical base portion 415 of the noble metal cip31 on the ignitability of the fuel. The search was conducted by sampling the cycle-by-cycle variations in combustion of fuel in the engine in the same manner as described above. Results of the tests are shown in a graph of FIG. 15. For the sake of convenience, the graph represents only for the case a condition of θ1=100° and G 0.5 mm which exhibits the greatest effect of the sectional area S5 on the ignitability of fuel.

The graph of FIG. 15 shows that when the sectional area S5 is greater than 0.95 mm² (i.e., a diameter of 1.0 mm), the percentage of the cycle-by-cycle variation in combustion exceeds the allowable limit M3, thus resulting in a difficulty in keeping the ignitability of fuel high. This is because the loss of flame on being cooled by the cylindrical base portion 415 increases. It is, thus, found that the sectional area S5 is preferably 0.95 mm² or less to ensure the higher degree of ignitability of fuel.

The inventor also performed durability tests on samples of the spark plug 1 of the second embodiment to search voltages required by the samples to discharge for different values of the angle θ1 of the frusto-conical portion 314. The tests were conducted by installing each of the test samples in the supercharged high-compression ratio engine and running it 200 thousand kilometers according to the same durability pattern, as described above, simulating the urban driving conditions.

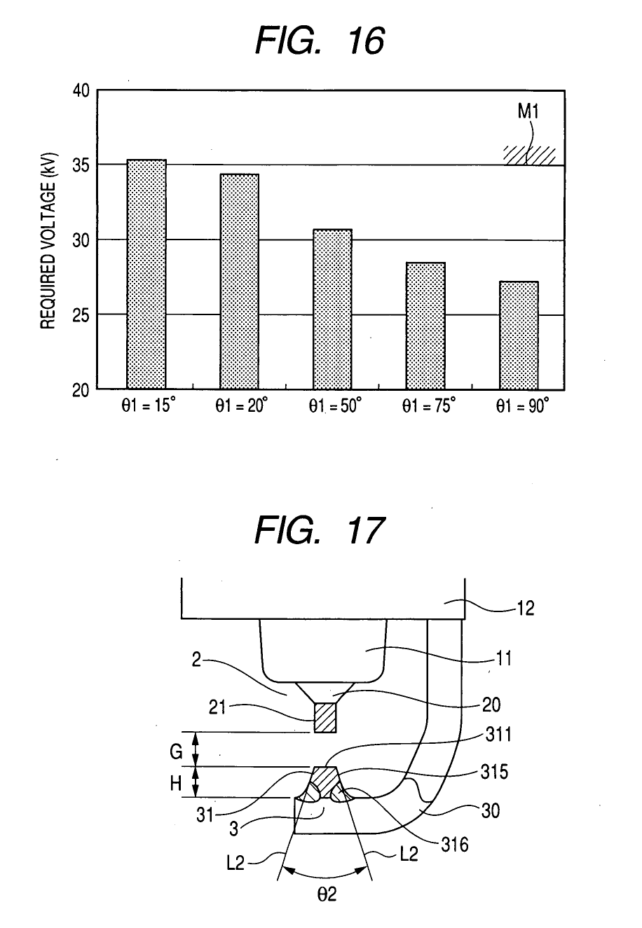

Results of the durability tests are shown in a graph of FIG. 16. The graph of FIG. 16 shows that a decrease in the angle θ1 results in a decrease in rate of increase in the spark gap, thus keeping the required voltage low, and when the angle θ1 is smaller than 20° the required voltage after the engine runs 200 thousand kilometers exceeds the allowable limit M1. It is, thus, found that the angle θ1 is preferably selected to be greater than or equal to 20° in terms of ensuring the higher degree of the ignitability of fuel.

FIGS. 16 to 20(d) show the spark plug 1 according to the third embodiment of the invention in which the noble metal chip 31 welded to the ground electrode body 30 has formed on at least a portion of the periphery thereof a wall 315 tapering toward the noble metal chip 21 of the center electrode 2. The noble metal chip 31 in this embodiment is of a frusto-conical shape as a whole.

The noble metal chip 31 is laser-welded to the surface of the ground electrode body 30 and joined thereto through fused portions (also called weld nuggets) 316 each made of a mixture of materials of the noble metal chip 31 and the ground electrode body 30 melted together during the laser-welding.

Each of the area of the top end surface 311 of the noble metal chip 31 of the ground electrode 3 and the sectional area of the noble metal chip 21 of the center electrode 2 is between 0.1 mm² to 0.6 mm². The angle θ2 which lines L2 make with each other is selected to be 7° or more. The lines L2 are defined to extend along the tapered wall 315 and be opposed diametrically to each other across the center of the top end surface 311.

The length G of the spark gap is, like the second embodiment, greater than or equal to 0.5 mm (G≧0.5 mm). When G<0.6 mm, the angle θ2 is preferably selected to meet a relation of θ2≦{100+200 (G−0.5 mm)}°. When G≧0.6 mm, the angle θ2 is preferably selected to be 120° or less. The angle θ2 is more preferably to meet a relation of 20°≦θ1≦100°

Process of laser-welding the noble metal chip 31 to the ground electrode body 30 will be described below.

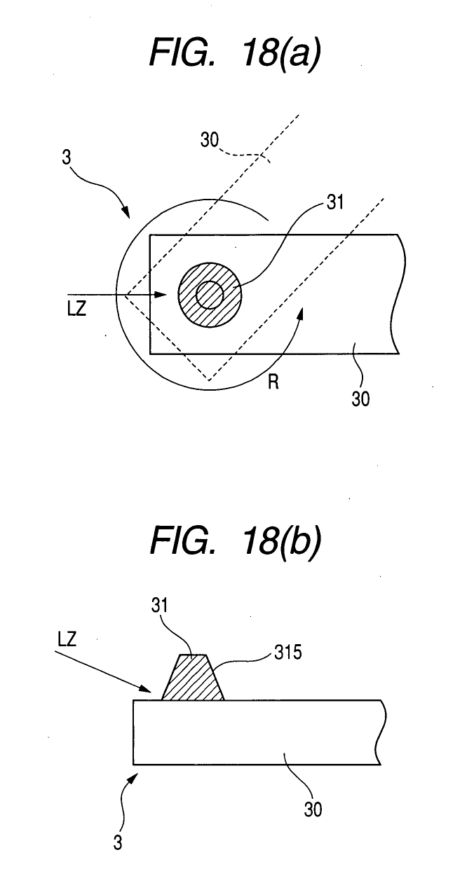

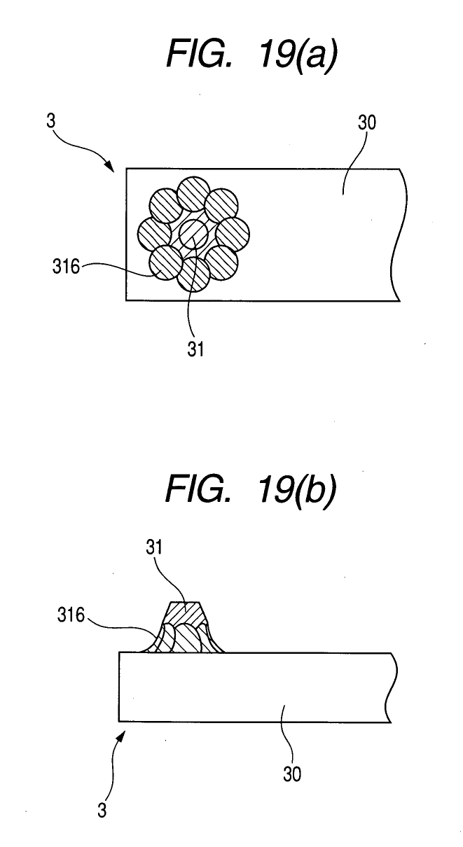

First, the frusto-conical noble metal chip 31 of 0.3 mm or more in length is, as clearly illustrated in FIGS. 18(a) and 18(b), placed at one of ends (i.e., a base end) thereof which is greater in sectional area on the surface of the ground electrode body 30. A laser beams LZ is, as can be seen from FIG. 18(b), radiated to an interface between the noble metal chip 31 and the ground electrode body 30 to form the fused portion 316. Subsequently, an assembly of the noble metal chip 31 and the ground electrode body 30 is, as indicated by an arrow R in FIG. 18, rotated about the longitudinal center line of the noble metal chip 31 to form the fused portions 316, as illustrated in FIGS. 19(a) and 19(b), around the whole of the circumference of the noble metal chip 31. For example, a total of eight (8) laser beams are emitted at an angular interval of 45° to form the eight fused portions 316.

Each of the laser beams LZ is, as clearly illustrated in FIG. 18(b), directed diagonally, i.e., at a slant angle to the surface of the ground electrode body 30. For instance, the leaser beams LZ is oriented at substantially right angles to the surface of the tapered wall 315. Instead of rotating the assembly of the noble metal chip 31 and the ground electrode body 30, the welding may alternatively achieved by rotating a laser emitter (not shown) around the noble metal chip 31 or using another known technique.

The welding of the noble metal chip 31 to the ground electrode body 30 may be made in any of assembling processes of the spark plug 1, as described below.

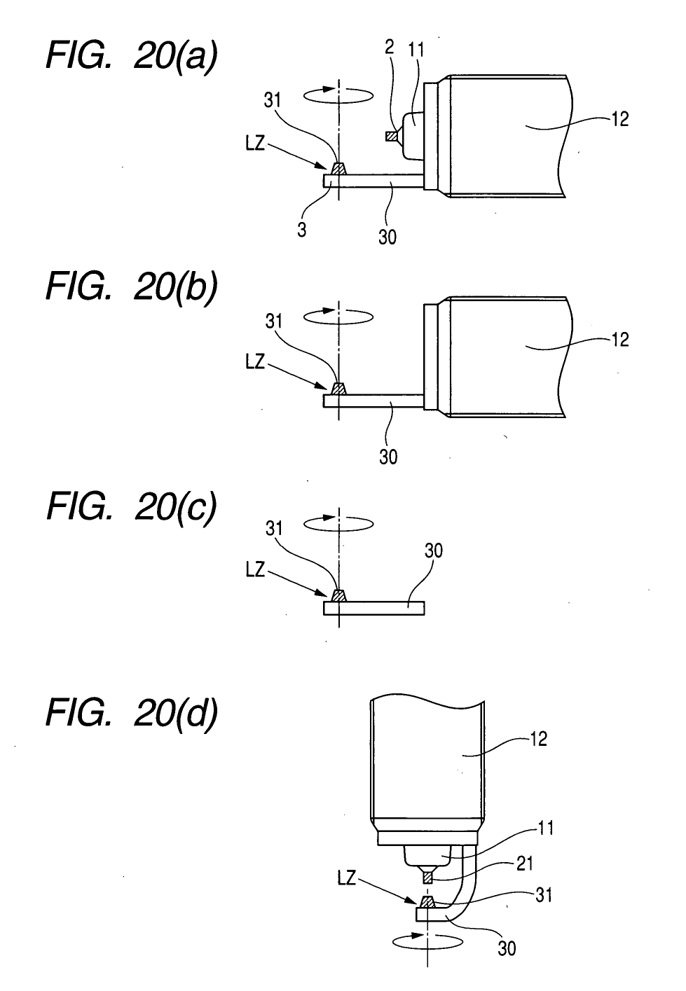

First, the ground electrode body 30 extending straight is, as clearly shown in FIG. 20(a), welded to the metal shell 12. The porcelain insulator 11 is installed in the metal shell 12. Afterwards, the laser beams LZ are emitted to weld the noble metal chip 31 to the ground electrode body 30. Finally, the ground electrode body 30 is bent at right angles.

The ground electrode body 30 extending straight is, as illustrated in FIG. 20(b), welded to the metal shell 12. Next, the laser beams LZ are emitted to weld the noble metal chip 31 to the ground electrode body 30 before installing the porcelain insulator 11 in the metal shell 12.

The laser beams LZ are, as illustrated in FIG. 20(c), emitted to weld the noble metal chip 31 to the ground electrode body 30 before the ground electrode body 30 is welded to the metal shell 12.

The laser beams LZ are, as illustrated in FIG. 20(d), emitted to weld the noble metal chip 31 to the ground electrode body 30 after the ground electrode body 30 is welded to the metal shell 12, the porcelain insulator 11 is installed in the metal shell 12, and the ground electrode body is bent at right angles.

The noble metal chip 31 may be designed to have any shape other than the truncated cone. Other arrangements are identical with those in the first embodiment, and explanation thereof in detail will be omitted here.

The advantages, as provided by the structure of the spark plug 1 of the third embodiment, will be described below.

The noble metal chip 31 of the ground electrode 3, as described above, has the tapered wall 315. In other words, the noble metal chip 31 is made up of a thinner top end portion and a thicker bottom end portion, thus keeping the ignitability of fuel high and decreasing the rate of increase in the voltage required by the spark plug 1 to discharge for the same reasons, as described in the first embodiment.

The tapered wall 315 serves to minimize the formation of dimples in the noble metal chip 31 arising from the laser-welding of the noble metal chip 31 to the ground electrode body 30, thereby ensuring the conductivity of heat from the noble metal chip 31 to the ground electrode body 30 to retard the wear of the noble metal chip 31. This decreases the rate of increase in the required voltage to prolong the service life of the spark plug 1. The minimization of the formation of dimples also serves to ensure the strength of the weld between the noble metal chip 31 and the ground electrode body 30.

The area of the top end surface 311 of the noble metal chip 31 of the ground electrode 3 and the sectional area of the center electrode chip 21 are each between 0.1 mm² to 0.6 mm², thereby ensuring a higher degree of the ignitability of fuel and decreasing the rate of increase in voltage required by the spark plug 1.

The angle θ2 of the inclination of the tapered wall 315 is, as described above, 7° or more, thereby facilitating the minimization of formation of the dimples in the noble metal chip 31 arising from the laser-welding.

The noble metal chip 31 is of the frusto-conical shape, thereby keeping the focus of the laser beams LZ constant around the periphery of the noble metal chip 31 when the laser beams LZ are, as illustrated in FIGS. 18(a) and 18(b), emitted to the noble metal chip 31 while rotating the noble metal chip 31, which results in the formation of the fused portions 316 which are uniform in size.

The length G of the spark gap is selected to be greater than or equal to 0.5 mm (G≧0.5 mm). When G<0.6 mm, the angle θ2, as can be seen in FIG. 17, is selected to meet the relation of θ2≦{100+200 (G−0.5 mm)}°. When G≧0.6 mm, the angle θ2 is selected to meet a relation of θ2≦100°. This ensures the higher degree of the ignitability of fuel.

Additionally, the angle θ2 may be selected to be 100° or less to improve the ignitability of fuel and 20° or more to minimize an undesirable rise in the required voltage to increase the service life of the spark plug 1.

The noble metal chip 31 is welded to the ground electrode body 30 in the manner, as illustrated in FIGS. 18(a) to 19(b), thus minimizing the formation of dimples in the noble metal chip 31, which avoids unusual wear of the noble metal chip 31 and ensures the strength of the weld between the noble metal chip 31 and the ground electrode body 30.

The orientation of emission of the laser beams LZ is, as illustrated in FIG. 18(b), at an angle to the surface of the ground electrode body 30, thereby resulting in the formation of the fused portions 316 which are uniform in size. To this end, the laser beams LZ are preferably emitted from a direction as close to the vertical as possible.

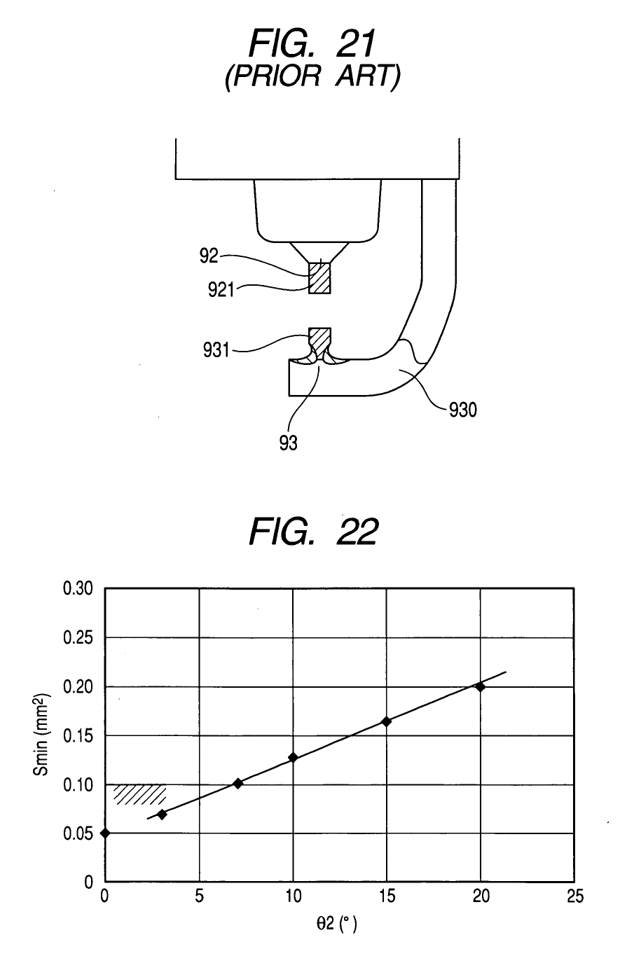

FIG. 21 demonstrates a comparative example of the spark plug 9, as illustrated in FIG. 4, wherein the noble metal chip 931 is laser-welded to the ground electrode body 930 in the same manner as illustrated in FIGS. 18(a) to 19(b) to form fused portions 316.

The radiation of laser beams to the noble metal chip 931 which is of a cylindrical shape having a constant diameter will, as illustrated in FIG. 21, result in formation of dimples around the interface between the noble metal chip 931 and the ground electrode body 930, thereby decreasing the conductivity of heat from the noble metal chip 931 to the ground electrode body 930, leading to premature wear of the noble metal chip 931. Particularly, a decrease in diameter of the noble metal chip 931 will result in a difficulty in ensuring the reliability of the laser-welding.

The inventor also performed tests on samples of the spark plug 1 of the third embodiment to find a preferable relation between the angle θ2 of the tapered wall 315 of the noble metal chip 31 of the ground electrode 3 and the formation of dimples in the fused portions 316 arising from the laser-welding. The evaluation was made based on a minimum sectional area Smin of the noble metal chip 31 at the fused portions 316. When the minimum section area Smin was 0.1 mm² or more, it was found to avoid the unusual wear of the noble metal chip 31 arising from a decrease in conductivity of heat to the ground electrode body 30. The inventor, therefore, searched values of the angle θ2 ensuring the minimum sectional area Smin of 0.1 mm² or more. Searched results are shown in a graph of FIG. 22.

The graph shows that when the angle θ2 is 70 or more, the minimum sectional area Smin will be 0.1 mm² or more. It is, thus, found that when the angle θ2 is 7° or more, it serves to avoid the undesirable wear of the noble metal chip 31 to ensure the reliability of the weld between the noble metal chip 31 and the ground electrode body 30.

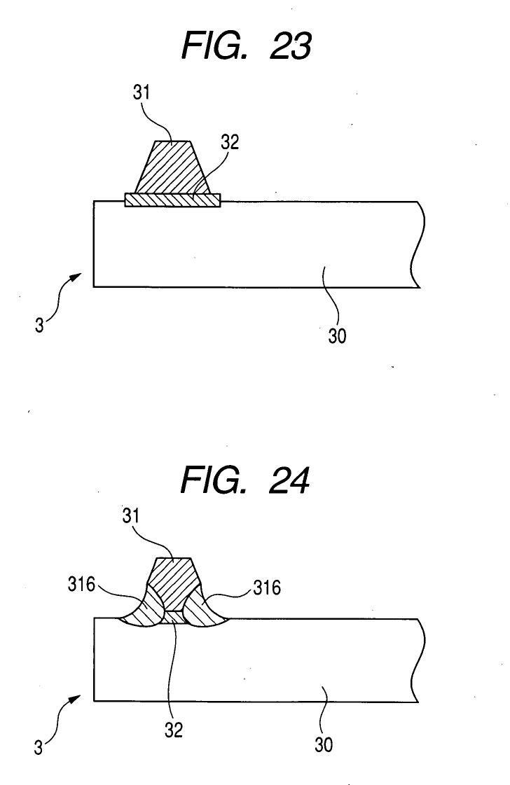

FIG. 23 shows the fourth embodiment of the invention in which the noble metal chip 31 is welded to the ground electrode body 30 through a disc plate 32 which has a coefficient of linear expansion intermediate between those of the noble metal chip 31 and the ground electrode body 30.

The joining of the noble metal chip 31 to the ground electrode body 30 is achieved by placing the disc plate 32 between the noble metal chip 31 and the ground electrode body 30 and connecting them through the resistance welding.

FIG. 24 shows a modification of the ground electrode 3 of FIG. 23. The joining of the noble metal chip 31 to the ground electrode body 30 is achieved by placing the disc plate 32 between the noble metal chip 31 and the ground electrode body 30, tack-welding them through the resistance welding, and emitting laser beams to form the fused portions 316 to establish a tight joint between the noble metal chip 31 and the ground electrode body 30.

For example, the ground electrode body 30 is made of an Ni-alloy. The noble metal chip 31 is made of a Pt—Rh alloy. In this case, the disc plate 32 is preferably made of a Pt—Ni alloy.

Other arrangements of the spark plug 1 are identical with those in the third embodiment, and explanation thereof in detail will be omitted here.

The structure, as illustrated in either of FIGS. 23 and 24, serves to minimize the thermal stress on the noble metal chip 31 and the ground electrode body 30, thus resulting in improved reliability of the joint between the noble metal chip 31 and the ground electrode body 30.

The welding of the noble metal chip 31 to the ground electrode body 30 may alternatively be made in another known manner.

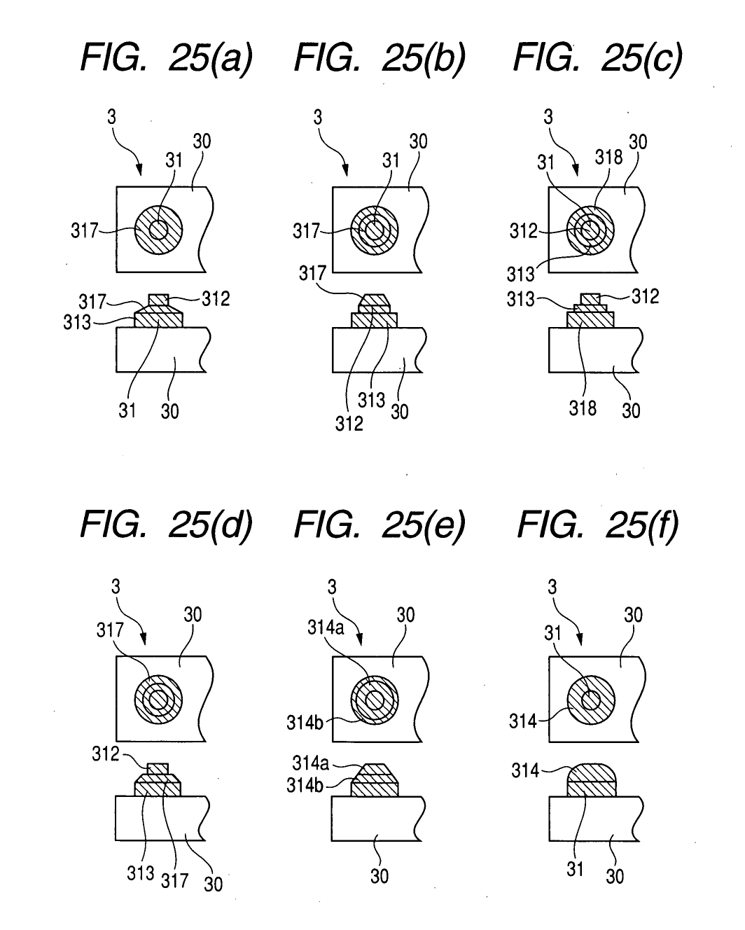

FIGS. 25(a) to 27(d) illustrate modifications of the ground electrode 3 in the first or second embodiment.

The noble metal chip 31, as illustrated in FIG. 25(a), has an annular tapered portion 317 formed between the minimum sectional are portion 312 and the second sectional area portion 313.

The noble metal chip 31, as illustrated in FIG. 25(b), has the annular tapered portion 317 defining a top end of the minimum sectional are portion 312. In other words, the noble metal chip 31 is designed to have a combination of the structures in the first and second embodiments.

The noble metal chip 31, as illustrated in FIG. 25(c), has a third sectional area portion 318 formed between the second sectional area portion 313 and the ground electrode body 30. The third sectional area portion 318 is greater in sectional area (i.e., the diameter) than the second sectional area portion 313. This structure is useful in terms of ease of keeping the rate of increase in the required voltage low to prolong the service life of the spark plug 1.

The noble metal chip 31, as illustrated in FIG. 25(d), has the annular tapered portion 317 defining a top end of the second sectional are portion 313.

The noble metal chip 31, as illustrated in FIG. 25(e), has the frusto-conical portion 314, as shown in FIG. 3, made up of a first and a second annular tapered portion 314a and 314b which are different in tapered angle from each other.

The noble metal chip 31, as illustrated in FIG. 25(f), has the frusto-conical portion 314 with a rounded outer peripheral surface.

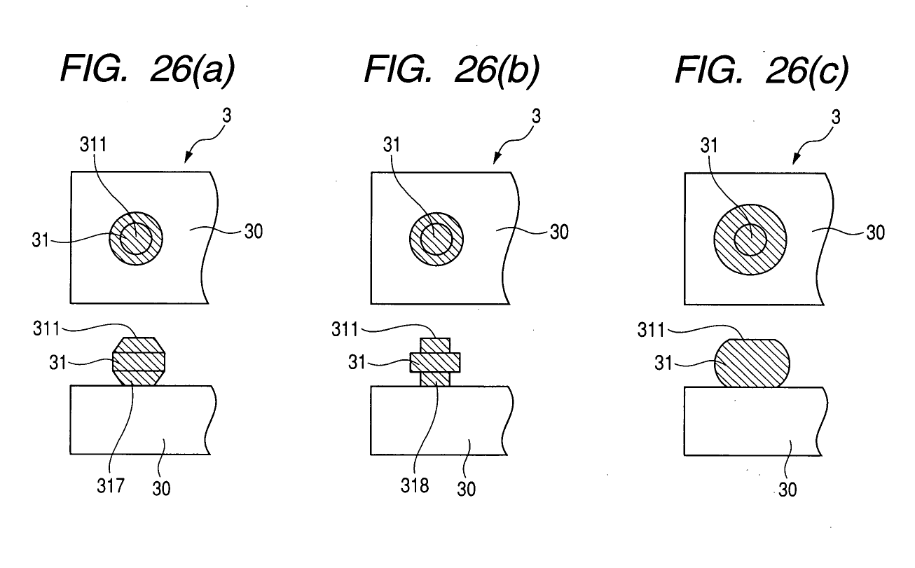

The noble metal chip 31 may be designed to have another shape which has a portion whose sectional area extending perpendicular to the longitudinal center line of the noble metal chip 31 is greater than that of the top end portion of the noble metal chip 31. For example, the noble metal chip 31 may be shaped, as illustrated in FIGS. 26(a) to 26(c), to have the greatest sectional area at a longitudinal intermediate portion thereof and smaller sectional areas at a top and a bottom end portion thereof.

The noble metal chip 3, as illustrated in FIG. 26(a), has an annular portion 317 tapering from a longitudinal central portion thereof toward the ground electrode body 30.

The noble metal chip 31, as illustrated in FIG. 26(b), has a third sectional area portion 318 formed between the second sectional area portion 313 and the ground electrode body 30. The third sectional area portion 318 is smaller in sectional area (i.e., the diameter) than the second sectional area portion 313.

The noble metal chip 31, as illustrated in FIG. 26(c), has a bulging outer peripheral wall whose diameter is the greatest at a longitudinal central portion of the noble metal chip 31. In other words, the noble metal chip 31 has a vertical sectional area whose outline is of an arc-shape.

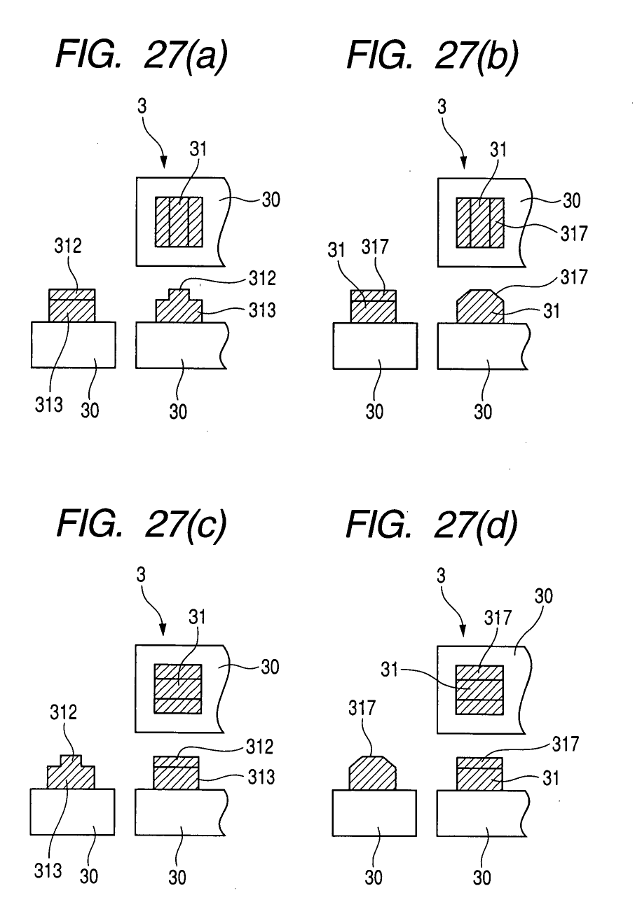

The noble metal chip 31 may alternatively be designed to have an axisymmetrical shape, as illustrated in FIGS. 27(a) to 27(d).

The noble metal chip 31, as illustrated in FIG. 27(a), is made up of the minimum sectional area portion 312 and the second sectional area portion 313 which are identical in length, as defined in the widthwise direction of the ground electrode body 30, but different in thickness from each other, as defined in the longitudinal direction of the spark plug 1 (i.e., the vertical direction in the drawing).

The noble metal chip 31, as illustrated in FIG. 27(b), includes a tapered portion 317 having the same length as that of a main body thereof in the widthwise direction of the ground electrode body 30. The tapered portion 317 has slant surfaces formed on sides in the lengthwise direction (i.e., the lateral direction, as viewed in the drawing) of the ground electrode body 30.

The noble metal chip 31, as illustrated in FIG. 27(c), is made up of the minimum sectional area portion 312 and the second sectional area portion 313 which are identical in length, as defined in the lengthwise direction of the ground electrode body 30, but different in thickness from each other, as defined in the widthwise direction of the ground electrode body 30. In other words, the noble metal chip 31 is different in orientation from the one of FIG. 27(a) by 90°.

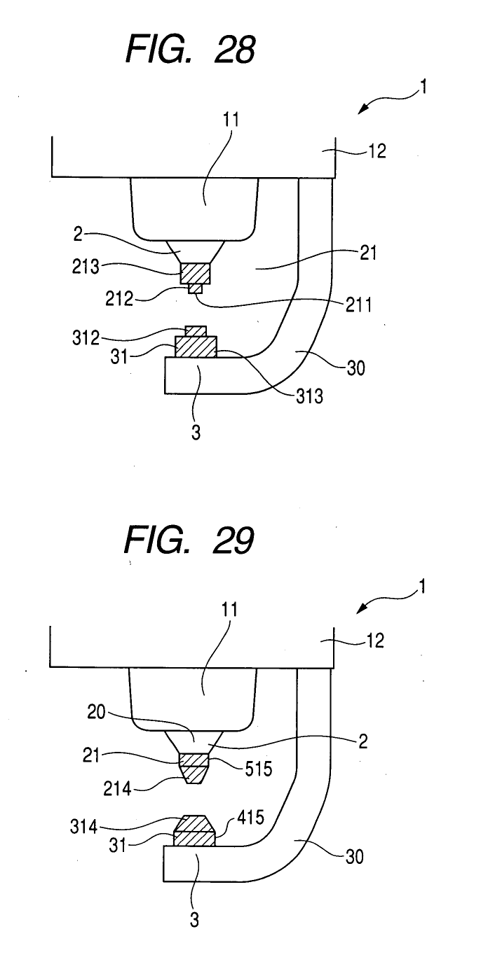

The noble metal chip 31, as illustrated in FIG. 27(d), includes the tapered portion 317 having the same length as that of a main body thereof in the lengthwise direction of the ground electrode body 30 (i.e., the lateral direction, as viewed in the drawing). The tapered portion 317 has slant surfaces formed on sides in the widthwise direction (i.e., the vertical direction, as viewed in the drawing) of the ground electrode body 30. In other words, the noble metal chip 31 is different in orientation from the one of FIG. 28(b), by 90°.

The noble metal chip 31 in each of the FIGS. 27(a) to 28(d) may alternatively be designed to have a line or rotational asymmetrical shape.

FIG. 28 shows the spark plug 1 according to the fifth embodiment of the invention which is a modification of the first embodiment, as illustrated in FIG. 2. Specifically, the noble metal chip 21 of the center electrode 2 is, like the noble metal chip 31 of the ground electrode 3, made up of a minimum sectional area portion 212 and a second sectional area portion 212 which is greater in sectional area (i.e., the diameter) than the minimum sectional area portion 212. Specifically, the noble metal chip 21 is similar in geometry to the noble metal chip 31 of the ground electrode 3.

FIG. 29 shows the spark plug 1 according to the sixth embodiment of the invention which is a modification of the second embodiment, as illustrated in FIG. 3. Specifically, the noble metal chip 21 of the center electrode 2 is, like the noble metal chip 31, made up of a frusto-conical portion 214 and a cylindrical base portion 515. The noble metal chip 21 is similar in geometry to the noble metal chip 31 of the ground electrode 3.

The noble metal chip 31 in each of FIGS. 28 and 29 may be designed to be of a cylindrical shape having a constant diameter.

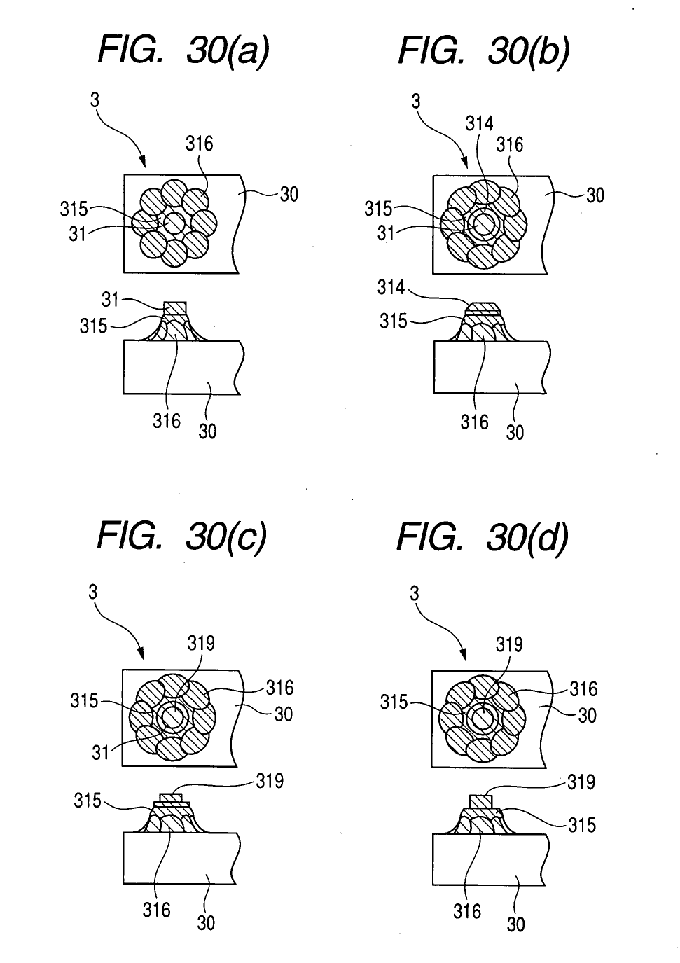

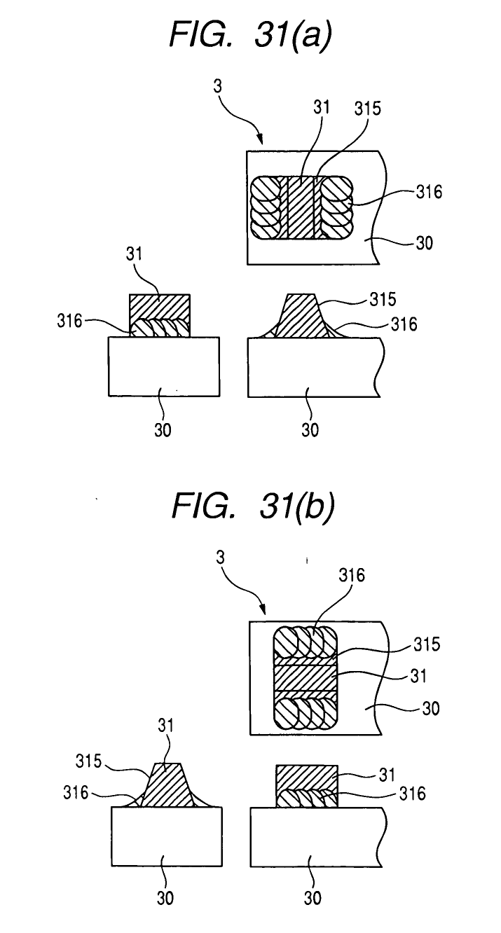

FIGS. 30(a) to 31(b) illustrate modifications of the spark plug 1 of the third embodiment, as illustrated in FIGS. 17 to 20(d).

The noble metal chip 31, as illustrated in FIG. 31(a), is made up of a top portion and a base portion closer to the ground electrode body 30 then the top portion. The base portion has the tapered wall 315. The top portion is, as can be seen from the drawing, of a cylindrical shape.

The noble metal chip 31, as illustrated in FIG. 31(b), made up of a top portion and a base portion closer to the ground electrode body than the top portion. The top portion is formed as the frusto-conical portion 314. The base portion has the tapered wall 315 extending in misalignment with an outer tapered wall of the frusto-conical portion 314. In other words, the tapered wall 315 does not lie flush with the outer tapered wall of the frusto-conical portion 314.

The noble metal chip 31, as illustrated in FIG. 30(c), is a modification of the one in FIG. 30(b). Specifically, the noble metal chip 31 has a cylindrical top portion 319 instead of the frusto-conical portion 314 in FIG. 30(b). The cylindrical top portion 319 is smaller in transverse sectional area than a based portion of the noble metal chip 31 which is welded directly to the ground electrode body 30 and has the tapered wall 315. The cylindrical top portion 319 is joined to the top surface of the base portion through an annular portion.

The noble metal chip 31, as illustrated in FIG. 30(e), is a modification of the one in FIG. 30(c). Specifically, the cylindrical top portion 319 is joined directly to the top surface of the base portion on the ground electrode body 30.

The noble metal chip 31 in each of FIGS. 31(a) and 31(b) is designed to have an axisymmetrical shape.

The noble metal chip 31, as illustrated in FIG. 31(a), includes tapered walls 315 formed on sides thereof to have a trapezoidal transverse sectional area extending in the lengthwise direction (i.e., the lateral direction in the drawing) of the ground electrode body 30. The noble metal chip 31 is welded to the ground electrode body 30 at the tapered walls 315 to form the fused portions 316 in the tapered walls 315.

The noble metal chip 31, as illustrated in FIG. 31(b), includes tapered walls 315 formed on sides thereof to have a trapezoidal transverse sectional area extending in the widthwise direction (i.e., the vertical direction in the drawing) of the ground electrode body 30. In other words, the noble metal chip 31 is different in orientation from the one of FIG. 31(a), by 90°. The noble metal chip 31 is welded to the ground electrode body 30 at the tapered walls 315 to form the fused portions 316 in the tapered walls 315.

The noble metal chip 31 in each of the FIGS. 30(a) and to 31(d) may alternatively be designed to have an asymmetrical shape.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A spark plug having a length for an internal combustion engine comprising:
a ground electrode having a center electrode facing surface;
a center electrode having a ground electrode facing surface;
a ground electrode noble metal chip joined to the center electrode facing surface of said ground electrode to have a top end surface oriented to said center electrode; and
a center electrode noble metal chip joined to the ground electrode facing surface of said center electrode to have a top end surface oriented to said ground electrode to define a spark gap between itself and the top end surface of said ground electrode noble metal chip,
wherein said ground electrode noble metal chip has a length, as extending from the center electrode facing surface in a lengthwise direction of the spark plug, which is 0.3 mm or more, at least one of said ground electrode noble metal chip and said center electrode noble metal chip includes a portion whose sectional area traversing a lengthwise direction of the spark plug is greater than an area of the top end surface of the at least one of said ground electrode noble metal chip and said center electrode noble metal chip.

2. A spark plug as set forth in claim 1, wherein said ground electrode noble metal chip is made up of a plurality of portions whose sectional areas traversing the lengthwise direction of the spark plug are different from each other, and wherein a minimum sectional area portion that is one of the plurality of portions having the smallest of the sectional areas is closest to said center electrode noble metal chip to have the top end surface.

3. A spark plug as set forth in claim 2, wherein each of sectional areas of the minimum sectional area portion and said center electrode noble metal chip lies within a range of 0.1 mm² to 0.6 mm².

4. A spark plug as set forth in claim 2, wherein the spark gap has a length G between the top end surfaces of said ground electrode noble metal chip and said center electrode noble metal chip, the minimum sectional area portion having a length h in the lengthwise direction of the spark plug, and wherein the lengths G and h are determined to meet relations of G≧0.5 mm and G+h≧0.8 mm.

5. A spark plug as set forth in claim 2, wherein the minimum sectional area portion has a length in the lengthwise direction of the spark plug which is 0.2 mm or more.

6. A spark plug as set forth in claim 2, wherein said ground electrode noble metal chip has a second sectional area portion that is one of the plurality of portions located adjacent the minimum sectional area portion, the second sectional area portion having a sectional area of 1.13 mm² or less.

7. A spark plug as set forth in claim 2, wherein the minimum sectional area portion has a length in the lengthwise direction of the spark plug which is 0.8 mm or less.

8. A spark plug as set forth in claim 2, wherein said ground electrode noble metal chip has a second sectional area portion that is one of the plurality of portions located adjacent the minimum sectional area portion, the second sectional area portion having a sectional area greater than that of said center electrode noble metal chip.

9. A spark plug as set forth in claim 1, wherein said ground electrode noble metal chip has at least a tapered top portion.

10. A spark plug as set forth in claim 9, wherein each of areas of the top end surface of said ground electrode noble metal chip and a sectional area of the center electrode noble metal chip lies within a range of 0.1 mm² to 0.6 mm².

11. A spark plug as set forth in claim 9, wherein the spark gap has a length G defined between the top end surfaces of said ground electrode noble metal chip and said center electrode noble metal chip, lines which are defined to extend along a peripheral surface of the tapered top portion and opposed diametrically to each other across a center of the top end surface of the ground electrode noble metal chip making an angle θ1 with each other, and wherein the length G is greater than or equal to 0.5 mm, when the length G is less than 0.6 mm, the angle θ1 meets a relation of θ1≦{100+200 (G−0.5 mm)}°, and when the length G is greater than or equal to 0.6 mm, the angle θ1 is 120° or less.

12. A spark plug as set forth in claim 9, wherein lines which are defined to extend along a peripheral surface of the tapered top portion and opposed diametrically to each other across a center of the top end surface of the ground electrode noble metal chip make an angle θ1 with each other which is 100° or less.

13. A spark plug as set forth in claim 9, wherein said ground electrode noble metal chip is made up of the tapered top portion and a base portion connected to the ground electrode, and wherein the base portion has a sectional area of 0.95 mm² or less.

14. A spark plug as set forth in claim 9, wherein lines which are defined to extend along a peripheral surface of the tapered top portion and opposed diametrically to each other across a center of the top end surface of the ground electrode noble metal chip make an angle θ1 with each other which is 20° or more.

15. A spark plug as set forth in claim 1, wherein at least one of said ground electrode noble metal chip and said center electrode noble metal chip is laser-welded to a corresponding one of said ground electrode and said center electrode.

16. A spark plug as set forth in claim 1, wherein said center electrode noble metal chip is made of one of a noble metal and a noble metal alloy which has a melting point of 1900° C. or more, and wherein said ground electrode noble metal chip is made of one of a noble metal and a noble metal alloy which has a melting point of 1700° C. or more.

17. A spark plug as set forth in claim 1, wherein the center electrode noble metal chip is made from alloy containing 50% or more by weight of one of Ir, Rh, and Ru, and wherein the ground electrode noble metal chip is made from alloy containing 50% or more by weight of one of Pt and Rh.

18. A spark plug as set forth in claim 1, wherein said ground electrode noble metal chip is joined to said ground electrode through a member which has a coefficient of linear expansion intermediate between those of said ground electrode noble metal chip and said ground electrode.

19. A spark plug as set forth in claim 1, wherein the spark gap has a length defined between said ground electrode noble metal chip and said center electrode noble metal chip, the length is 1.2 mm or less.

20. A spark plug having a length for an internal combustion engine comprising:
a ground electrode having a center electrode facing surface;
a center electrode having a ground electrode facing surface;
a ground electrode noble metal chip having a top portion and a base portion, said ground electrode noble metal chip being joined at the base portion to the center electrode facing surface of said ground electrode; and
a center electrode noble metal chip joined to the ground electrode facing surface of said center electrode to define a spark gap between itself and said ground electrode noble metal chip,
wherein said ground electrode noble metal chip has a length, as extending from the center electrode facing surface in a lengthwise direction of the spark plug, which is 0.3 mm or more, wherein at least the base portion tapers toward the top portion, and wherein said ground electrode noble metal chip is joined at the tapered base portion to the center electrode facing surface of said ground electrode through a laser welding-fused portion.

21. A spark plug as set forth in claim 20, wherein the top portion of said ground electrode noble metal chip has a top end surface facing said center electrode noble metal chip, and wherein an area of the top end surface and a sectional area of the center electrode noble metal chip lies within a range of 0.1 mm² to 0.6 mm².

22. A spark plug as set forth in claim 20, wherein lines which are defined to extend along a peripheral surface of the tapered base portion and opposed diametrically across an axial center of the tapered base portion make an angle with each other which is 7° or more.

23. A spark plug as set forth in claim 20, wherein at least of one of said ground electrode noble metal chip and said center electrode noble metal chip is of a frustro-conical shape.

24. A spark plug as set forth in claim 20, wherein the spark gap has a length G defined between said ground electrode noble metal chip and said center electrode noble metal chip, lines which are defined to extend along a peripheral surface of the tapered base portion and opposed diametrically across an axial center of the tapered base portion making an angle θ2 with each other, and wherein the length G is greater than or equal to 0.5 mm, when the length G is less than 0.6 mm, the angle θ2 meets a relation of θ2≦{100+200 (G−0.5 mm)}°, and when the length G is greater than or equal to 0.6 mm, the angle θ2 is 120° or less.

25. A spark plug as set forth in claim 20, wherein lines which are defined to extend along a peripheral surface of the tapered base portion and opposed diametrically across an axial center of the tapered base portion make an angle with each other which is 100° or less.

26. A spark plug as set forth in claim 20, wherein lines which are defined to extend along a peripheral surface of the tapered base portion and opposed diametrically across an axial center of the tapered base portion make an angle with each other which is 200 or more.

27. A spark plug as set forth in claim 20, wherein said center electrode noble metal chip is made of one of a noble metal and a noble metal alloy which has a melting point of 1900° C. or more, and wherein said ground electrode noble metal chip is made of one of a noble metal and a noble metal alloy which has a melting point of 1700° C. or more.

28. A spark plug as set forth in claim 20, wherein the center electrode noble metal chip is made from alloy containing 50% or more by weight of one of Ir, Rh, and Ru, and wherein the ground electrode noble metal chip is made from alloy containing 50% or more by weight of one of Pt and Rh.

29. A spark plug as set forth in claim 20, wherein said ground electrode noble metal chip is joined to said ground electrode through a member which has a coefficient of linear expansion intermediate between those of said ground electrode noble metal chip and said ground electrode.

30. A spark plug as set forth in claim 20, wherein the spark gap has a length defined between said ground electrode noble metal chip and said center electrode noble metal chip, the length is 1.2 mm or less.

31. A method of producing a spark plug for an internal combustion engine comprising:
preparing a ground electrode and a center electrode, the ground electrode having a center electrode facing surface, the center electrode having a ground electrode facing surface;
preparing a noble metal chip which includes a top portion and a base portion and has a length of 0.3 mm or more extending from the center electrode facing surface, at least the base portion tapering toward an end of the top portion to have a sectional area decreasing as approaching the end of the top portion;
placing the noble metal chip at the base portion on the center electrode facing surface of the ground electrode; and
radiating a laser beam to an interface between the base portion of the noble metal chip and the center electrode facing surface of the ground electrode to joint the noble metal chip to the ground electrode.

32. A method as set forth in claim 31, wherein the laser beam is emitted to the interface at a slant angle to the center electrode facing surface of the ground electrode to form a fused portion that is made from a mixture of materials of the noble metal chip and the ground electrode.

33. A method as set forth in claim 32, wherein the laser beams is oriented substantially perpendicular to a peripheral surface of the tapered base portion.
